(19) United States
(12) Patent Application Publication
(10) Pub. No.: US 2003/0061463 A1
(43) Pub. Date: Mar. 27, 2003

(54) Digital containers for proposal objects

(76) Inventor: John J. Tibbetts, San Francisco, CA (US)

Correspondence Address: FREDRIK MOLLBORN, Fish & Richardson P.C., 2200 Sand Hill Road, Suite 100, Menlo Park, CA, 94025, US

(21) Appl. No.: 09/962,757

(22) Filed: Sep. 24, 2001

Related U.S. Application Data
(60) Provisional application No. 60/287,062, filed on Apr. 27, 2001.

(51) Int. Cl. G06F 15/00

(52) U.S. Cl. 712/1

(57) ABSTRACT

Methods and apparatus, including computer program products, implementing and using techniques for maintaining proposal objects in a digital container object. Each proposal object holds data representing a proposed transaction in an uncommitted state. The digital container object includes computer program instructions, embodied in a tangible medium, to: detect an introduction of a first proposal object into the digital container object; detect a removal of the first proposal object from the digital container object; perform one or more actions on the first proposal object in the digital container object in response to the detected introduction or removal of the first proposal object; and apply access control conditions to limit the actions that can be performed by a user on the proposal objects in the digital container object. A system for organizing information in proposal objects and digital container objects is also described.

### BACKGROUND

This invention relates to data transactions of the kind that commonly arise in computer-enabled business processes.

Conventional business transaction applications usually involve linking a user interface with a database manager or transaction processing monitor controlling changes to a database or other type of asset store. Applications of this type are often very specialized and generally have to be created from scratch. The user inputs small chunks of information in dedicated fields, but the back-end resource typically deals with larger and more complex data structures. Therefore, an application developer has to map each small chunk of input data individually to its proper place in the more complex data structure in the back-end. In an organization that may need many applications in a year, the programming of applications of this type involves a significant cost in terms of labor and time, even if programming tools are available that make programming easier.

In order to create a more efficient way of producing and organizing applications of this kind, and open new, further automated ways for collaboration between companies using the infrastructure of the Internet, a new digital programming object—a “proposal object”, or simply a “proposal” when the sense is clear from the context—has been presented. A description of how proposals are implemented and used can be found in the commonly-owned U.S. Pat. No. 6,158,044, “Proposal Based Architecture System,” which is incorporated here by reference. A proposal is a “middle-tier object,” that is, an object that is independent of both a front-end and a back-end. Proposals can be accessed through diverse user interfaces and attached to a back-end and a front-end whenever needed, thus freeing up back-end resources. Proposals are non-visual and can be presented to a user in a variety of visual environments. Furthermore, proposals do not contain any information about either the front-end viewer or the back-end asset store, which they can be connected to at any given time.

A proposal has the ability to hold a proposed transaction from the moment the proposal is initiated until the moment the proposal's content is committed to a data store, that is, during the whole time the proposed transaction is being worked on. For example, an organization that would like to initiate a purchase or sale decides what to buy or sell by filling out and internally circulating a proposal. After the organization completes the proposal, the proposal is exposed to potential suppliers or buyers, who use the proposal to organize their responses. Negotiations between the organization and the suppliers or buyers can be done by changing, annotating, and resubmitting the proposal (or a derivative proposal based on the same material) to the other party. Finally, when the terms are agreed on, the proposal communicates with a formal transaction process, unloads the information contained in the proposal into a persistent back-end asset store, and ceases to exist.

### SUMMARY OF THE INVENTION

The invention provides a digital container object that is customized to contain proposal objects, to provide services for proposal objects, and to handle what will be referred to as “life-cycle events” of proposal objects. The container object of the invention will be referred to generically as a proposal container. In the detailed description portion of this specification, a particular implementation of a proposal container, called a ProposalSpace, will be described. A ProposalSpace is a proposal container for a Proposal, which is particular implementation of a proposal object.

A proposal container reduces the amount of non-reusable code that must be written to support proposal-based operations. Proposal containers generally have the following properties, which lead to a number of advantages. A proposal container is a digital container object that is persistent, can be distributed, and is customized to hold and handle the life-cycle events of proposals. Generally a proposal container includes an access control mechanism. Proposals generally hold work in progress, that is, proposed but uncommitted transactions. A proposal container is therefore specialized to handle events that are related to work getting done, as opposed to just data getting stored.

Proposal containers collaborate actively with the proposals they contain. This is possible because proposals are active and intelligent, not merely data that has to be manipulated from the outside. As a consequence of proposals being more complex than regular pieces of data that just get created and deleted, proposal containers must be able to handle more complex life cycles. Proposal containers are therefore able to intercept various proposal events, such as the proposals showing themselves to different users, moving into and out of a proposal container, changing their status, and so on. In response to these and other events, a proposal container can perform specialized behaviors.

Furthermore, as the work embodied by a proposal advances and the proposal changes its status, this may have an effect on other proposals. Because a proposal container can view many proposals at once, the proposal container can manage inter-proposal behavior and serve as a medium of communication among the proposals it contains.

A proposal container can manage the unique process of disposing of a proposal at the end of its life-cycle, or when otherwise instructed to do so. The disposing process commits the proposal's contents, that is, unloads the proposal and distributes the contents to one or more permanent asset stores, and either saves or deletes the proposal itself. In addition to managing each of these operations, a proposal container can coordinate them to ensure that the committing and saving/deleting operations happen automatically in the correct order. Even if some type of system failure were to occur, a proposal container would not archive a proposal as committed without actually having committed its values.

Proposal containers can be configured to collaborate with the proposals they contain to implement commercial processes, such as auctions, RFQs (Requests For Quotes), fulfillment, exchanges, and so on. They can also be configured to manage the conversion between proposals and flat data, which can be in XML, plain text, or other convenient format. Thus, proposal containers can serve as bridges between the “world of data” and the “world of work.” Proposal containers can aggregate a view of the work (proposals) of individual users that come together temporarily to accomplish a task, forming ad hoc work spaces in a peer-to-peer environment.

Proposal containers provide a convenient mechanism for controlling access to different kinds of proposals and other objects residing in a proposal container. For example, a “Republican Proposal Container” might provide extensive access rights to users holding the role “Republican,” while only a few, if any, rights are provided to users holding the role “Democrat.” A “Democrat Proposal Container” might reverse these access policies, but also provide a certain level of access to users holding the role “Green.”

Proposal containers can be implemented to define a method for partitioning a server process so that proposals used for one application can be kept separate from those used for another application, in a way similar to how different subdirectories can be used to aggregate similar kinds of files. For example, a container can keep sales order proposals separate from and administered differently from new hire proposals.

A proposal container can provide a place for associating properties of a proposal that depend on the proposal's context rather than on its inherent structure. For example, a proposal might define a source parameter that provides a logical name of a back-end domain asset (for example, a database). However, a user can under different circumstances want the same proposal to hook up to a different database instance. By making the source parameter a property of the proposal container, rather than of the proposal itself, the proposal can be kept free of domain asset commitments.

Proposal containers can be nested, which allows access control to be very sophisticated without being complex to manage. The scope of a property can also be controlled by whether it is put on an outer or an inner proposal container. If, for example, every sales order proposal in an organization uses the same database instance, this property can be put on an outermost proposal container. However, if different sales order proposals use different databases, this can be managed by putting them into different, nested, proposal containers with a local database-pointing property attached to the containers.

Finally, proposal containers can be constructed to provide a hierarchic arrangement that does not need a corresponding structure of physical servers. A rich hierarchy can be implemented on a single computer, broken up across many servers, or change from one to another without affecting the operation of the proposals.

Therefore, in general, in one aspect, the invention provides methods and apparatus, including computer program products, implementing and using techniques for organizing information. A system in accordance with this aspect of the invention includes a computer program subsystem. The computer program subsystem includes instructions operable to cause the system to maintain a first digital container object for containing proposal objects and to perform actions on the proposal objects. The instructions include instructions to receive a first proposal object, the first proposal object holding data that represents a proposed transaction in an uncommitted state, and add the received first proposal object to the first digital container object; to release and remove the first proposal object from the first digital container object; to store in a non-volatile memory a then-current state of all proposal objects in the first digital container object and of the first digital container object itself; to control access by a user to the first digital container object and to proposal objects in the first digital container object; and to perform one or more actions on the first proposal object in response to an event related to the first proposal object or an event related to the first digital container object. The actions include completing any data processing associated with the first proposal object, submitting the first proposal object for further processing to a second computer program subsystem maintaining a second digital container object for containing proposal objects, and performing one or more actions on the first proposal object when it is received to be added to the first digital container object.

Advantageous implementations can include one or more of the following features. The event can be triggered by the first proposal object. The event can be triggered by a second proposal object in the first digital container object. The event can be a time-related event. The event can be a proposal life-cycle event.

The actions in response to the instructions to complete any data processing associated with the proposal object can include moving data contained in the proposal object to a permanent asset store and either archiving the proposal object in a permanent asset store or deleting the proposal object from the system.

The subsystem can be distributed for execution by two or more independently operating computers. The subsystem can include instructions to perform an action on the first proposal object in the first digital container object based on information related to a second proposal object in the first digital container object and to a state of the subsystem. The subsystem can include instructions to obtain data from the first proposal object in the first digital container object and supply the data to the second proposal object in the first digital container object. The subsystem can include instructions to obtain data from the first proposal object in the first digital container object and supply the data to a data document. The data document can be an XML document. The subsystem can include instructions to obtain data from a data document and supply the data to the first proposal object in the first digital container object.

The instructions to control access by a user to the first digital container object and to proposal objects in the first digital container object can include instructions to associate the user with a role and associate the role with specific access rights. The actions can be context dependent actions. The actions can be customizable by a user.

The first digital container object can be contained in a nested structure of digital container objects. The first digital container object can be in a second digital container object in the nested structure and inherit one or more properties of the second digital container object. The nested structure of digital container objects can be independent of the physical structure of the platforms hosting the digital container objects.

In general, in another aspect, the invention provides methods and apparatus, including computer program products, implementing and using techniques for administering a collection of digital container objects. A system in accordance with this aspect of the invention includes a registry server and a registry database. Each digital container object is defined by computer program instructions and data configured to be loaded onto and executed by a computer process and the registry server includes a computer process operating in communication with the registry database. The system further includes container-configuration data for multiple digital container objects, the container-configuration data for each digital container object including a specification defining the digital container object; instructions executable by the registry server to use the container-configuration data for any of the multiple digital container objects in creating a digital container object satisfying the corresponding specification on a particular computer; container-location data specifying a computer location for each digital container object created in conjunction with the registry server, whereby any such digital container object can locate any other such digital container object; and container-store data for each digital container object specifying a persistent store for the corresponding digital container object, whereby any such digital container object can be saved and retrieved by the system. The digital container objects collectively operate to create, contain, transfer, operate on, and terminate digital proposal objects each representing a proposed transaction in an uncommitted state. The digital container objects include a first digital container object that interacts with a user and performs a specialized activity on proposal objects contained in the first digital container object.

Advantageous implementations can include one or more of the following features. The registry server and database can include instructions executable by the registry server to use registry database data to configure a computer process as a digital container object server, the digital container object server being a computer process registered with the registry server and configured to host one or more digital container objects.

The container-configuration data for a digital container object can include data specifying access control parameters for the digital container object, and the specialized activity can include an action performed when a proposal object enters the first digital container object and an action performed when a proposal object leaves the first digital container object. The system can further include instructions executable to migrate a proposal object from one digital container object to another digital container object.

The digital container objects in the collection can perform a particular kind of activity, such as matching buyers and sellers, enabling collaboration on a product design, assembling group orders or bids, aggregating forecasts or projections composed of input from multiple sources, prioritizing or ranking multiple offers or entries.

In general, in another aspect, this invention provides methods and apparatus, including computer program products, implementing and using techniques for maintaining proposal objects in digital container objects, each proposal object holding data representing a proposed transaction in an uncommitted state. The digital container object includes computer program instructions embodied in a tangible medium implementing methods operable to: detect an introduction of a first proposal object into the digital container object; detect a removal of the first proposal object from the digital container object; perform one or more actions on the first proposal object in the digital container object in response to the detected introduction or removal of the first proposal object; and apply access control conditions to limit the actions that can be performed by a user on the proposal objects in the digital container object.

Advantageous implementations can include one or more of the following features. The digital container object can include instructions implementing methods operable to perform one or more actions on a second, different proposal object in the digital container object in response to the detected introduction or removal of the first proposal object. The methods operable to detect an introduction of the first proposal object can include methods to detect a creation of the first proposal object in the digital container object. The methods operable to detect an introduction of the first proposal object can include methods to detect an immigration of the first proposal object into the digital container object from another digital container object. The methods operable to detect a removal of the first proposal object can include methods to detect a deletion of the first proposal object from the digital container object. The methods operable to detect a removal of the first proposal object can include methods to detect an emigration of the first proposal object from the digital container object to another digital container object.

The digital container object can include methods operable to perform one or more actions on one or more proposal objects in the digital container object in response to an instruction generated by a proposal object in the digital container object. The digital container object can include methods to perform one or more actions on one or more proposal objects in the digital container object in response to a time-related event. The digital container object can include methods to perform one or more actions on one or more proposal objects in the digital container object in response to a life-cycle event for a proposal object.

The digital container object can include methods operable to store in a non-volatile memory a then-current state of the digital container object and to cause the proposal objects contained in the digital container object to store their own then-current states in a non-volatile memory so as to create a persistent digital container object with a persistent state including contained proposal objects.

The digital container object can include methods operable to detect a complete event for a proposal object, the proposal object holding data representing a proposed transaction; move the data contained in the proposal object to a permanent asset store; and store the proposal object in a permanent asset store or delete the proposal object. The digital container object can include methods operable to obtain data from a data document and supply the data to the first proposal object in the digital container object. The data document can be an XML document. The digital container object can include methods operable to obtain data from the first proposal object in the first digital container object and supply the data to a data document.

The action can be a context-dependent action. The action can be customizable by a user. The methods operable to apply access control conditions can include methods operable to associate a user with a role and associate the role with specific rights to access all the proposal objects in the digital container object. The methods operable to apply access control conditions can include methods operable to associate the role with specific rights to introduce or remove proposal objects from the digital container object. The digital container object can be distributed on two or more servers in communication over a network. The proposal object can be a middle-tier object that is independent of both any front-end and any back-end.

The details of one or more implementations of the invention are set forth in the accompanying drawings and the description below. Other features and advantages of the invention will be apparent from the description and drawings.

### BRIEF DESCRIPTION OF DRAWINGS

FIG. 1 is an illustration of a set of nested ProposalSpaces in accordance with the invention.

FIG. 2 is a block diagram showing an on-line business process flow using Proposals and ProposalSpaces in accordance with the invention.

FIGS. 3A-3D illustrate different states of Proposals and ProposalSpaces in an on-line business process in accordance with the invention.

FIG. 4 illustrates the organization of the ProposalRegistry objects, in accordance with the invention.

FIG. 5 is an illustration showing how a client application addresses a ProposalSpace through a ProposalServer at run-time in accordance with the invention FIGS. 6A-6C show three different representations of the relationships of ProposalSpaces in accordance with the invention.

FIG. 7 shows an exemplary central ProposalSite and an exemplary ProposalSite hosted by a user or organization in accordance with the invention.

FIG. 8 shows an internal class structure of the ProposalServer in accordance with the invention.

FIG. 9 shows a schematic view of an alternative implementation of ProposalSpaces in an EJB (Enterprise Java Bean) environment.

Like reference symbols in the various drawings indicate like elements.

### DETAILED DESCRIPTION

Proposals offer great flexibility in performing business transactions. Proposals can be effectively hard-wired into applications, with site-specific application logic specifying how proposals are created, how proposals operate, how proposals interact with each other, and what finally becomes of the proposals. However, this requires surrounding proposals with considerable non-reusable programming. Much of this proposal-manipulation can be abstracted. In many cases, several interacting proposals will be controlled by the same rules and have identical structure. Proposal containers in accordance with the invention provide a simple way to abstract and reuse proposal-management logic that would otherwise have to be hand-coded into each application, and to control the behavior of multiple proposals in a given situation.

Proposal containers can be implemented as self-contained, stand-alone application programs. They can also be implemented in an object environment such as an EJB (Enterprise Java Beans) environment.

As mentioned earlier, ProposalSpaces are a particular implementation of proposal containers, implemented for Proposals, which are a particular implementation of proposal objects. A self-contained, stand-alone implementation of ProposalSpaces will now be described. This will be followed by a description of an alternative implementation of ProposalSpaces, in which ProposalSpaces are implemented in an EJB environment.

In the following description, three different aspects ProposalSpaces will be explained: the conceptual aspect, the run-time aspect, and the development aspect.

### THE CONCEPTUAL ASPECT OF PROPOSALSPACES

Conceptually, a ProposalSpace is a place where groups of Proposals and other software objects are held and managed. Behavior can be imposed on Proposals by the ProposalSpace that is holding them. This behavior is configurable at the ProposalSpace level. This section focuses on a high-level description of ProposalSpaces and their behavior.

In a computerized work process built upon a Proposal architecture, Proposals generally move among different ProposalSpaces, where different users can see and work on the Proposals and/or various automated processes can take control of the Proposals. Each ProposalSpace imposes a set of “rules of governance” on the Proposals and other types of objects that are contained within the ProposalSpace while the Proposals are there. Some ProposalSpaces serve as collaboration areas where Proposals can be viewed, discussed, and modified by authorized users. Other ProposalSpaces are configured to implement various business processes, so that Proposals are transformed in some way as they move through the ProposalSpace.

A set of ProposalSpaces can be distributed across machines and across organizations. Each organization maintains a master ProposalSpace called a ProposalSite, where the organization's user management taxonomy, firewall-level security, common naming conventions, and so on are enforced. The ProposalSite includes a number of subordinate ProposalSpaces. Each of these subordinate ProposalSpaces is generally designed to represent some level of collaboration or some business process. A global ProposalRegistry of ProposalSites and their ProposalSpaces assures that any ProposalSpace can find any other ProposalSpace, regardless in what ProposalSite the ProposalSpace is located. Local ProposalRegistries can contain caches of remote but frequently accessed ProposalSpace definitions for rapid access across ProposalSite boundaries.

The concept of “place” that ProposalSpaces implement has two aspects: containment (where Proposals live) and rules of governance (the policies that govern life in that ProposalSpace). The containment properties are typically generic and common to all ProposalSpaces and include behaviors such as admitting, expelling, holding, controlling access to, and providing information about the Proposals within the ProposalSpace. The rules of governance, by contrast, are configurable and cause a ProposalSpace to specialize in a certain kind of activity, such as running auctions, clearing exchanges, maintaining catalogs, displaying Proposals for collaborative consideration, and so on. Business policies of different levels of complexity can be implemented by building into ProposalSpaces a set of rules that govern with precision what happens to a Proposal upon entering a particular ProposalSpace, what happens before the Proposal is allowed to leave, and how the Proposal conducts itself during its stay in the ProposalSpace.

ProposalSpaces operate on Proposals by intervening at certain points in the Proposal life cycle. Proposal birth, death, immigration, emigration, commitment, submission, and reversion are all events on which a given ProposalSpace can impose refinements, effectively controlling what happens next to the Proposal. A brief description of the Proposal life cycle events follows below.

Birth: Every Proposal comes into being inside a ProposalSpace. Immediately upon creation, the ProposalSpace gets a chance to influence the new Proposal. The ProposalSpace can, for example, initialize data values or set up security parameters. Thus the structure and behavior built into the Proposal by the specification on which it is based can be modified or added to by the policies of the ProposalSpace into which that Proposal is born. This is an example of how intelligence contained within the Proposal and intelligence contained within the ProposalSpace that holds that Proposal work together to provide multiple levels of customization.

Death: A user, an outside agent, the Proposal itself, or the ProposalSpace can determine that a Proposal has reached the end of its life. Before the Proposal is actually deleted, the ProposalSpace has a chance to act, performing whatever behaviors the ProposalSpace has been programmed to perform on moribund Proposals. Such behaviors may include logging the date and time of deletion, saving a copy in an archive, sending an e-mail alerting somebody, or even refusing to delete the Proposal in certain cases.

Immigration: Default immigration behavior is to let a Proposal enter a ProposalSpace. However, a ProposalSpace can be set up so that any entering Proposal initiates a series of actions on itself. These actions can include verifying that the Proposal is permitted entry into that ProposalSpace, registering the Proposal as a member of the ProposalSpace, applying certain constraints on the Proposal, examining the content of the Proposal in order to determine what to do next, or transferring some or all of the contents of the Proposal to a somewhat differently-structured Proposal.

Emigration: A Proposal's leaving a ProposalSpace is another event that can cause behavior to be initiated. The ProposalSpace can manipulate the Proposal on its way out just as the ProposalSpace manipulated the Proposal on its way in, making sure that the Proposal has fulfilled all of its obligations in that ProposalSpace and is ready for the next ProposalSpace.

Commitment, Submission, Reversion: There are three more life-cycle events at which the ProposalSpace can operate on a Proposal. When the Proposal has received the instruction to commit itself (update resources), submit itself (move on to the next step according to customizable instructions inherited from the Proposal specification), or revert itself (go back a step), the ProposalSpace can determine exactly how this will be done.

In addition to these life-cycle events, custom function hooks that have been built into the ProposalSpaces may prompt ProposalSpace actions. These function hooks can be activated by an external function, by a timer-driven agent, or by some other event. This makes it possible, for example, to set an auction to clear at a given time of day or after a certain period of inactivity. Another use of function hooks is to move Proposals into ProposalSpaces that handle the Proposals differently as they age.

What steps a ProposalSpace takes at any of the events described above is configurable. A ProposalSpace can be programmed to impose different actions depending on the type of Proposal being operated upon. For example, a “buy Proposal” and a “sell Proposal” residing in the same ProposalSpace can move around and find partners according to different algorithms.

ProposalSpaces present a way to solve what is known as the “organizational integrity problem.” Organizations are often reluctant to abandon proprietary processes or to expose these processes to business partners even for the sake of participating in some sort of cross-enterprise collaborative network. These processes can be implemented in a locally maintained ProposalSpace inside a firewall that is open (insofar as access control permits) to Proposals from partners. A Proposal submitted to a business partner moves into one of the partner's ProposalSpaces where it is manipulated by the behaviors built into that ProposalSpace. Collaborating organizations cannot see into or participate in each other's internal systems. The organizations only send Proposals, which are able to follow the procedures of the ProposalSpace in which they arrive while keeping the organization's processes opaque to the outside world.

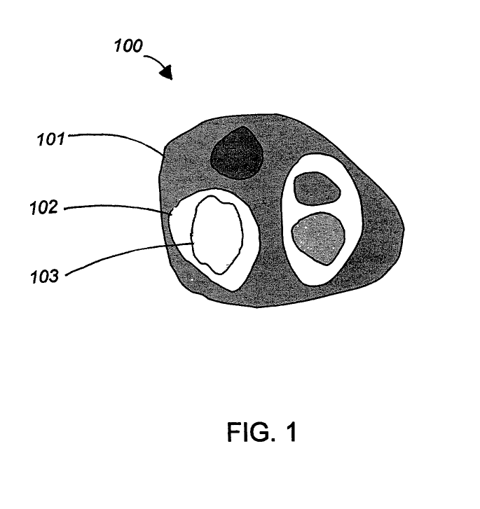

ProposalSpaces can contain other ProposalSpaces, each inheriting infrastructure from its parent and adding its own refinements. The inheritance structure lets every “interior” ProposalSpace pick up the rules of the one or more ProposalSpaces that surround it, thereby creating a shared global vocabulary with local variations. Similarly, as shown in FIG. 1, a set of nested ProposalSpaces (100) can enforce increasingly tight levels of security. For example, everybody in an organization may have access to the outermost ProposalSpace (101), but only purchasing agents may have access to a ProposalSpace inside the outermost ProposalSpace (102), and only purchasing agents with bidding clearance can have access to a ProposalSpace inside the “second level” ProposalSpace (103). Nested ProposalSpaces are a natural mechanism for organizations that wish to collaborate privately and then expose the results to a wider group of people or organizations.

Objects Contained By a ProposalSpace

In addition to containing Proposals, a ProposalSpace can contain additional types of objects. Some examples of these additional objects include:

PropSpecs, which are the specifications or templates for different types of Proposals. A specific instance of a Proposal is created from a PropSpec. The PropSpec must be in the ProposalSpace in which the Proposal will be created.

Other ProposalSpaces, nested as described above.

DomainObjects, which hold data fetched from some persistent data store, structure the data in a form that can be used by PropSpecs, and make the data available to the Proposals within the ProposalSpace.

TypeSpecDictionaries, which are collections of reusable field definitions that can be incorporated into any new Proposals in that ProposalSpace.

Scripts, which are packages of programmed actions that perform some application function.

RoleDefinitions, which are definitions of the types of users who will be using a ProposalSpace application and consequently interacting with the ProposalSpace and its contents. These definitions are used to control access to the ProposalSpace and the objects it contains.

XML documents to which the ProposalSpace application might need to refer.

Text documents to which the ProposalSpace application might need to refer.

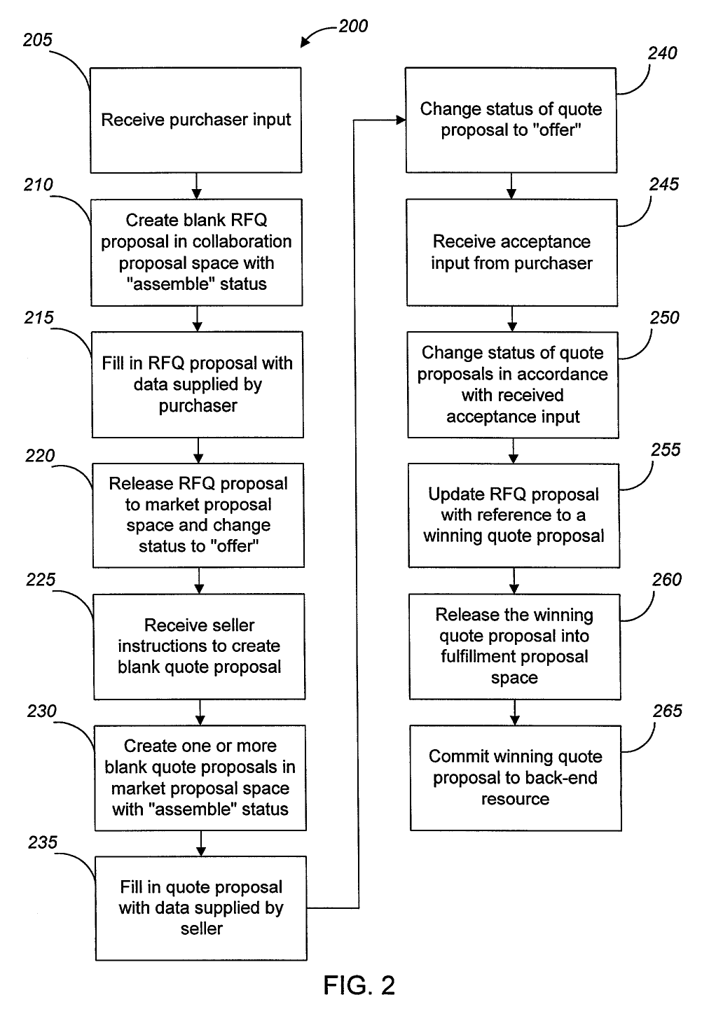

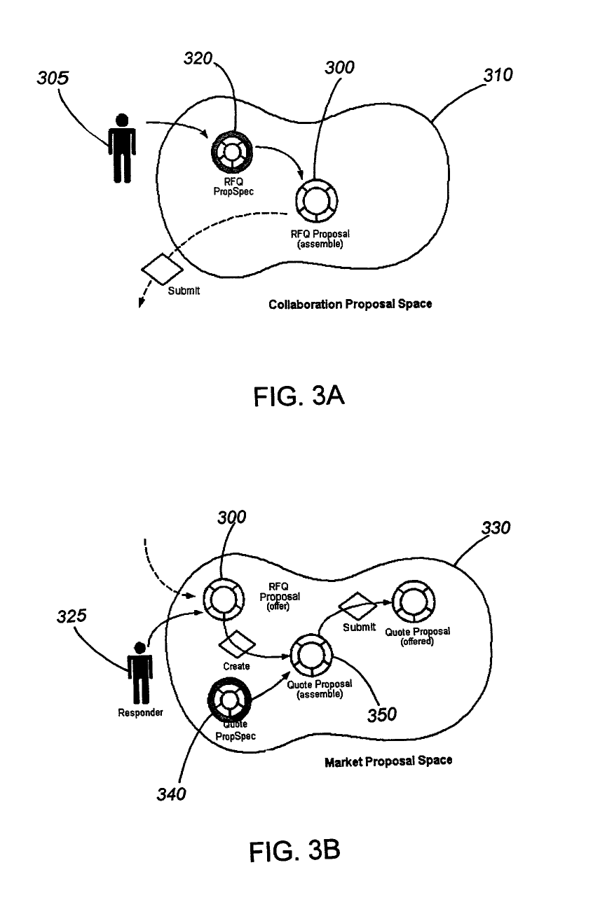

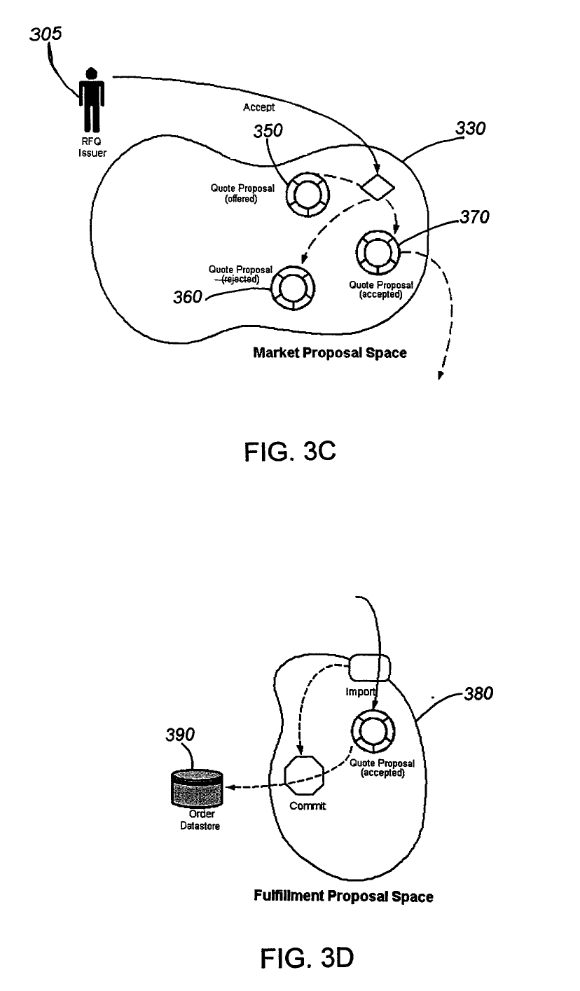

An example of how ProposalSpaces can be used to perform a business transaction in an on-line marketplace will now be presented with reference to FIGS. 2 and 3A-3D.

Proposal—ProposalSpace Interaction: An Example

FIG. 2 is a block diagram showing an on-line business process flow using Proposals and ProposalSpaces in accordance with the invention. The different steps of the process are also illustrated in FIGS. 3A-3D that show different ProposalSpaces and their content at given times while the process in FIG. 2 is performed. The process represents the issuing and response to RFQs (Requests for Quote) submitted into an on-line marketplace. The process begins by receiving a user input from a purchaser (305) who wants to buy a certain product (step 205). As shown in FIG. 3A, after receiving the user input, the process creates a blank RFQ (Request For Quote) Proposal (300) in a collaboration ProposalSpace (310) created in an on-line marketplace (step 210). The collaboration ProposalSpace (310) contains a Proposal specification (320) that serves as a template for the marketplace's RFQ Proposals.

The blank RFQ Proposal then receives a user input of data about the specific purchase that the purchaser is requesting quotes for (step 215). As long as the Proposal (300) is in the collaboration ProposalSpace (310), the Proposal has an “assemble” status. The Proposal is only visible to, and can only be modified by, employees that belong to the organization issuing the RFQ Proposal and that have the appropriate access permission to the collaboration ProposalSpace (310). When the RFQ Proposal is completed, the process receives a user input to submit the RFQ Proposal, which moves the RFQ Proposal out of the collaboration ProposalSpace into to the market ProposalSpace shown in FIG. 3B (330; step 220).

In addition to moving the RFQ Proposal (300) into the market ProposalSpace (330), the submit action changes the RFQ Proposal status from “assemble” to “offer.” The RFQ Proposal now becomes visible to suppliers. A seller (325) views the RFQ Proposal and if the seller is interested in offering the requested product, the process then receives instructions from the seller to create a quote Proposal that reflects much of the information in the RFQ to which it is responding (step 225). The process creates a quote Proposal (350) using metadata from the quote Proposal specification (340) that resides in the market ProposalSpace (330) and picks up some instance data from the RFQ Proposal to which the quote Proposal is responding (step 230). The process then adds data supplied by the seller (possibly in collaboration with his or her colleagues) to the quote Proposal (step 235). Just like the RFQ Proposal, the quote Proposal (350) has the status “assemble” until it is complete. During this time the quote Proposal (350) is visible only to people within the quoting organization having permission to see the Proposal. When the quote Proposal is complete, the quote Proposal is submitted. This action changes its status to “offer,” (step 240). The quote Proposal (350) remains in the market ProposalSpace (330), but the change of status makes the quote Proposal visible to the organization that issued the RFQ.

The purchasers (305) at the organization that issued the RFQ Proposal review the quote Proposal (350) and all other quote Proposals that have been offered in response to their RFQ Proposal (300). They accept one of them (step 245). When a quote Proposal is accepted, the status of the winning quote Proposal changes to “accepted” and the Proposal moves out of the market ProposalSpace into a fulfillment ProposalSpace (step 250). The status of all other quote Proposals changes to “rejected” and nothing more is done with them. The original RFQ Proposal is subsequently updated with a reference to the winning quote Proposal (step 255).

The importation of the accepted quote Proposal into the fulfillment ProposalSpace (380; step 260) triggers behavior that commits the accepted Proposal and extracts the data contained in the accepted Proposal for storage in a permanent back-end asset store (390; step 265). This ends both the life of the quote Proposal and this phase of the on-line business process.

### THE RUN-TIME ASPECT OF PROPOSALSPACES

This section describes the physical implementation of ProposalSpaces and how they interact with individual Proposals.

The ProposalSite

The proposal container implementation being described has an administrative element called a ProposalSite. A ProposalSite is a collection of ProposalSpaces (and other architectural elements) and a registry database called a ProposalRegistry. The ProposalRegistry is a cache of configuration data that is related to a ProposalSite and will be described in further detail below. The ProposalSpaces are hosted on one or more proposal servers, in the present implementation called ProposalServers. The ProposalRegistry is hosted on a ProposalRegistry server.

A ProposalSite defines the administrative boundary of a project or an application. The ProposalSite typically corresponds to a company, but it can represent any organization, such as a department, a consortium, or a marketplace.

A ProposalSite has a certain coherence in that it is administered as a unit. A ProposalSite definition often includes a contact name, phone number, and e-mail address as well as a single ProposalSite URL. All ProposalSpaces and servers within a ProposalSite must have unique names, so that they can be uniquely addressed. User management information, used for authentication and access control, is handled at the ProposalSite level, that is, each ProposalSite maintains its own set of user names, passwords, and group affiliations. Security within a ProposalSite can be more relaxed than security among ProposalSites.

Like ProposalSpaces, ProposalSites can be nested. In one sense, all ProposalSites are administrative divisions of a larger network of ProposalSites with the potential to interact in a variety of ways. A global ProposalRegistry of ProposalSites makes it possible for any ProposalSpace to be addressed by name—its name being the name of the ProposalSite plus the name of the ProposalSpace, and therefore unique.

The ProposalRegistry

ProposalSpaces are defined in a database called a ProposalRegistry. The ProposalRegistry resides on a ProposalRegistry server, stores specifications for one or many ProposalSpaces (and other architectural elements) and loads the specifications into the memory of a computer as required, for example, when a ProposalSite is initialized. The specifications for a ProposalSite are contained in a Registry file that is read into the Proposal registry. More specifically, the ProposalRegistry manages the network addresses, administrative information, authentication type, parent ProposalSite, and permission to have child ProposalSites for a ProposalSite. For the ProposalServer, the ProposalRegistry manages the network address and the ProposalSite ownership. For the ProposalSpaces the ProposalRegistry manages the one or more servers that host the ProposalSpaces, where and in what form Proposals will persist, specialized sub-class implementations, properties, and ProposalSpace access control. All of these features will be described in further detail below.

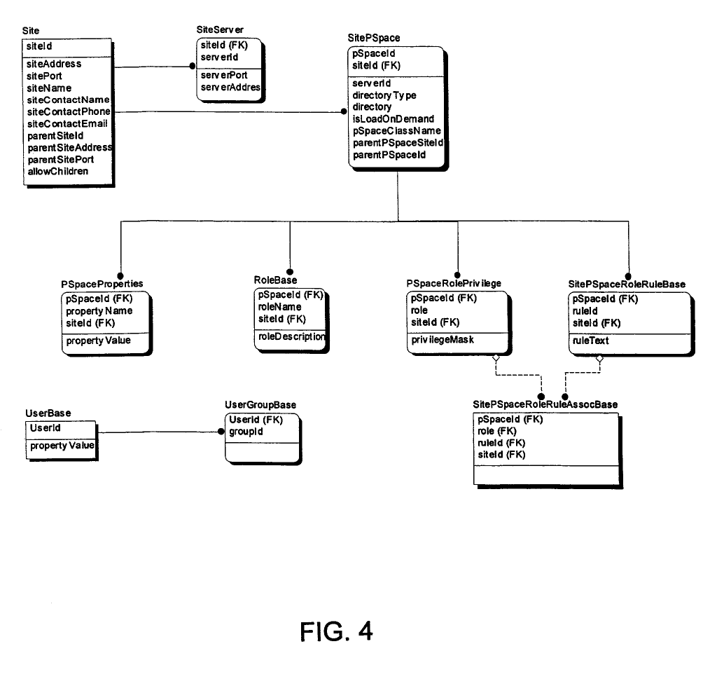

A graphic illustration of the organization of the architectural elements in the ProposalRegistry is provided in the ProposalRegistry object structure, shown in FIG. 4. Table 1 below summarizes the high-level ProposalRegistry object structures of FIG. 4. The high-level ProposalRegistry object structures referred to as domain objects, which are objects that can be used by a Proposal or a ProposalSpace to access data in an external source, such as a database. A Logical Object ID (LOID) is a field or fields that define the uniqueness of each domain object.

TABLE 1
High-level ProposalRegistry object structures

| Domain | | | |
|---|---|---|---|
| object | Description | LOID | Attributes |
| Site | Information | siteId | siteAddress (externally |
| | about a | | accessible IP or DNS address); |
| | ProposalSite | | sitePort (port number of |
| | | | ProposalRegistry); |
| | | | parentSiteId (name of parent |
| | | | site; if empty, site is parentless); |
| | | | parentSiteAddr (address of |
| | | | parent site); |
| | | | parentSitePort (port of parent |
| | | | site); |
| | | | allowChildren (site can |
| | | | have subsites; otherwise deny) |
| siteServer | Information | SiteId, | serverAddress (externally |
| | about a | serverId | acccessible IP or DNS address); |
| | ProposalServer | | serverPort (port number of |
| | within a | | ProposalServer) |
| | ProposalSite | | |
| sitePSpace | Information | SiteId, | serverId (ID of the |
| | about a | pSpaceId | ProposalServer serving this |
| | ProposalSpace | | ProposalSpace); |
| | within a | | directory (virtual |
| | ProposalSite | | directory holding Pspace); |
| | | | pSpaceClassName (class |
| | | | name implementing custom |
| | | | space behavior); |
| | | | accessMgrClassName (class |
| | | | name implementing access |
| | | | manager); |
| | | | parentPSpaceId (parent |
| | | | ProposalSpace ID); |
| | | | parent PspaceSiteId (parent |
| | | | ProposalSpace site ID) |

ProposalSpaces are defined by adding configuration data to the ProposalRegistry and are then created at run-time from the specifications in the ProposalRegistry. The information that must be provided to the ProposalRegistry in order for the ProposalRegistry to initialize a ProposalSpace is shown in Table 2 below.

TABLE 2
Information required to create a ProposalSpace

| Required | |
|---|---|
| Information | Description |
| ProposalSpace name | Any name unique to the ProposalSite. |
| Parent | A ProposalSpace from which the ProposalSpace to |
| ProposalSpace | be created can inherit behaviors and properties, if a |
| | Parent ProposalSpace exists. |
| Storage type and | How and where the ProposalSpace stores its |
| location | objects. |
| Name of the | Where the unique behaviors of this ProposalSpace |
| ProposalSpace | are defined. |
| sub-class file | |
| Site ID | The site in which the ProposalSpace is located. |
| Server ID | The name of the server being used. |

The ProposalServer

Each ProposalSite acts as a logical parent to one or more ProposalServers. Each ProposalServer, in turn, can host many ProposalSpaces. Any ProposalSpace in a network of ProposalServers can be hosted on any ProposalServer. There is no requirement that the ProposalSpaces defined for a ProposalSite need to actually be served by a server that is associated with that ProposalSite. Multiple different ProposalServers can be deployed on one or multiple computers within a ProposalSite. A ProposalServer can communicate with the ProposalRegistry and load definitions from the ProposalRegistry into its memory to create functioning objects.

A startup sequence is defined between a ProposalRegistry for a particular ProposalSite and its ProposalServers. When a ProposalServer starts up, the ProposalServer makes a request to the ProposalRegistry of the associated ProposalSite for permission to start. The ProposalServer will be allowed to start only if the ProposalServer is defined in the ProposalRegistry. The ProposalServer obtains instructions from the ProposalRegistry about how to configure itself, what classes to run, what ProposalSpaces to host, and what first class objects those ProposalSpaces will contain. The concept of first-class objects will be explained below under the heading “Working with first class objects.”

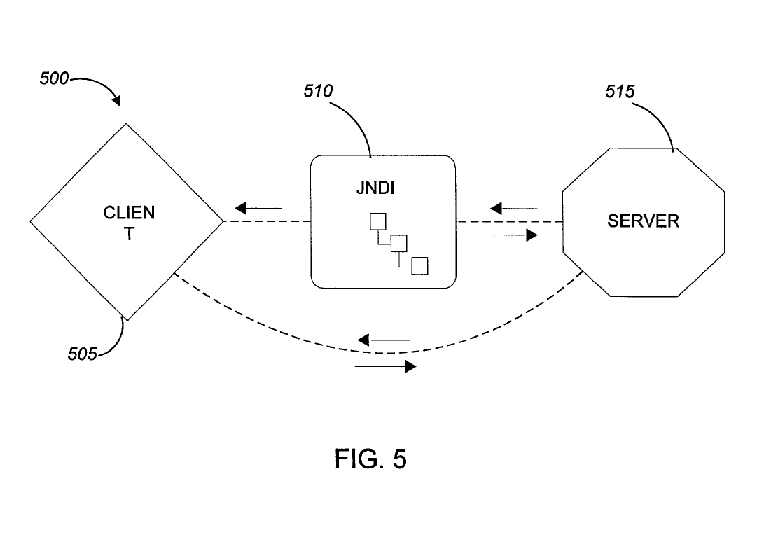

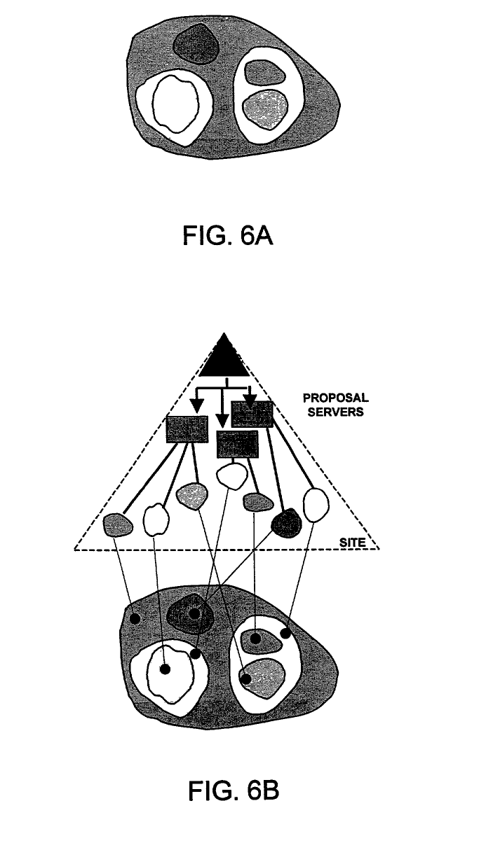

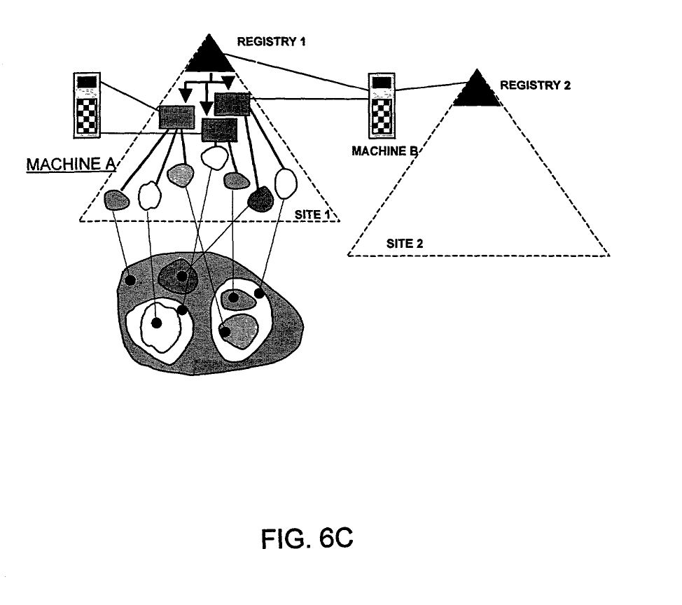

FIG. 5 shows one implementation of how a client application (500) addresses a ProposalSpace through the ProposalServer at run-time in accordance with the invention. Any client application or process (500) that wants to interact with a ProposalSpace uses a Java Naming and Directory Interface (JNDI) (510) to provide the location of the ProposalSpace in question. The JNDI returns the location and address of the ProposalServer hosting that ProposalSpace. The client can then directly address the ProposalServer (515) that hosts the ProposalSpace that the client wants to interact with.

FIGS. 6A-6C show a summary of three distinct ways to envision the relationships of ProposalSpaces.

FIG. 6A illustrates the conceptual relationship of ProposalSpaces with some ProposalSpaces nested within, or neighboring to, other ProposalSpaces as organizational structures, inheritance of properties, and access control dictates.

FIG. 6B illustrates the process relationship of ProposalSpaces as run-time creations of a series of ProposalServers associated with one or multiple ProposalSites mapped against the conceptual view. As can be seen in FIG. 6B, there is no necessary relationship between how ProposalSpace management is distributed among various ProposalServers and how those ProposalSpaces appear to relate to one another. Nested ProposalSpaces can be hosted by completely different ProposalServers.

FIG. 6C illustrates the physical relationship of ProposalRegistries and ProposalServers that are actually located on physical machines. A single computer can hold the ProposalRegistry files and servers for multiple ProposalSites, along with one or more ProposalServers for each of these ProposalSites. ProposalServers belonging to two different ProposalSites can be hosted by the same machine.

Distributed ProposalSpaces

ProposalSpaces can be deployed on user equipment. This might be done for reasons of user control, use of internal data centers, concern for security and control of the ProposalSpaces themselves or a desire to keep tight control over the assets that those ProposalSpaces access (such as internal catalogs and databases).

On the other hand, ProposalSpaces generally need to interoperate with other ProposalSpaces. In particular, many ProposalSpaces will need to pass Proposals to other ProposalSpaces. Finally, one may wish to migrate an entire ProposalSpace to another ProposalSite.

ProposalSpaces can be distributed among several computers or servers. This can be done, for example, if the following requirements are met:

An organization or user who wishes to host a ProposalSite needs to register with a service provider to support a ProposalSite.

The service provider needs to approve the registration.

All ProposalSites need to obtain an acceptable digital certificate from a recognized and mutually agreeable certificate authority.

The ProposalSpace server needs to be installed on a user platform, possibly within the user's or organization's firewall.

Exchange of Proposals (or even ProposalSpaces) with other ProposalSites must be encrypted with the parties' certificates to ensure security.

Transaction details need to remain the private property of the user or organization.

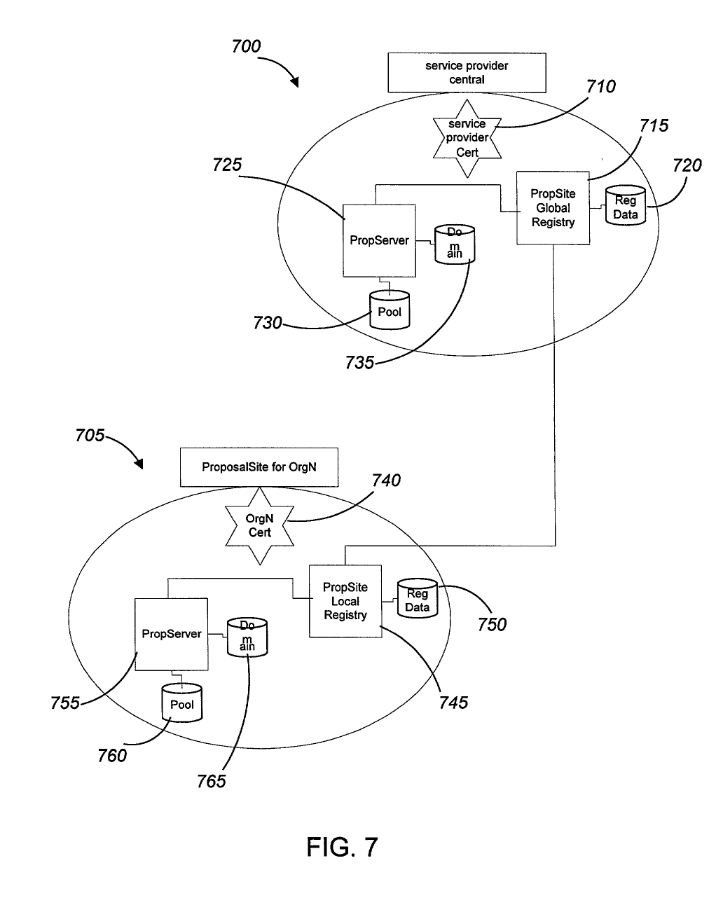

FIG. 7 shows an exemplary central ProposalSite (700) at a service provider and an exemplary ProposalSite (705) that is hosted by a user or organization. The service provider certificate (710) is an organization digital certificate that enables identification and supports public key infrastructure (PKI). PropSite Global Registry (715) together with the accompanying database (720) is a data store registering all ProposalSpaces in the network to which the service provider is connected. The global ProposalRegistry is optionally mirrored in a geographically distant spot. PropServer (725) is a ProposalSpace server that hosts a ProposalSpace that assigns ProposalSpaces to users or organizations. Pool (730) is the persistent store of active Proposals. Domain (735) is the asset store or stores of the Proposals which are accessed through a Domain Coordinator. At the ProposalSite (705) that is hosted by a user or organization, the OrgNCert (740) is an organization digital certificate enabling identification and supporting PKI. PropSite Local Registry (745) together with the accompanying database (750) is a data store registering local ProposalSpaces and caching frequently used distant ProposalSpaces. Note that this ProposalRegistry also informs the service provider's GlobalRegistry (715) of ProposalSpace registration, deregistration, and usage. The PropServer (755), Pool (760) and Domain (765) have the same functionality as described above. The communication between global and local ProposalSite registries is optionally encrypted. A reasonable transport is either or both of remote method invocation (RMI) over a secure socket layer (SSL) (Java Development Kit (JDK) version 2 and above) and HTTPS. The HTTPS transport may be more firewall friendly.

In one implementation of the invention, one way for an organization or user to obtain ProposalSpaces to host on their own hardware platform is as follows: The organization starts with registering with a service provider. Important registration elements are the IP address or addresses of the one or more ProposalSites plus an acceptable digital certificate from a recognized certificate authority. The service provider then reviews and approves the registration. When the registration is approved, the service provider manufactures a license object that includes the license information locked to the supplied IP address and certificate. This object is sent to the organization. The organization then downloads a ProposalSite bundle and installs it. The organization continues by configuring their ProposalSite and specifies the database for registration, pool and domain. Note that domain URL properties (and other properties) are allocated by the ProposalSpace. This allows cloned ProposalSpaces to carry the same internal domain URLs but point at different data stores. Finally the organization starts ordering and configuring ProposalSpaces.

### THE INTERNAL STRUCTURE OF THE PROPOSAL SERVER

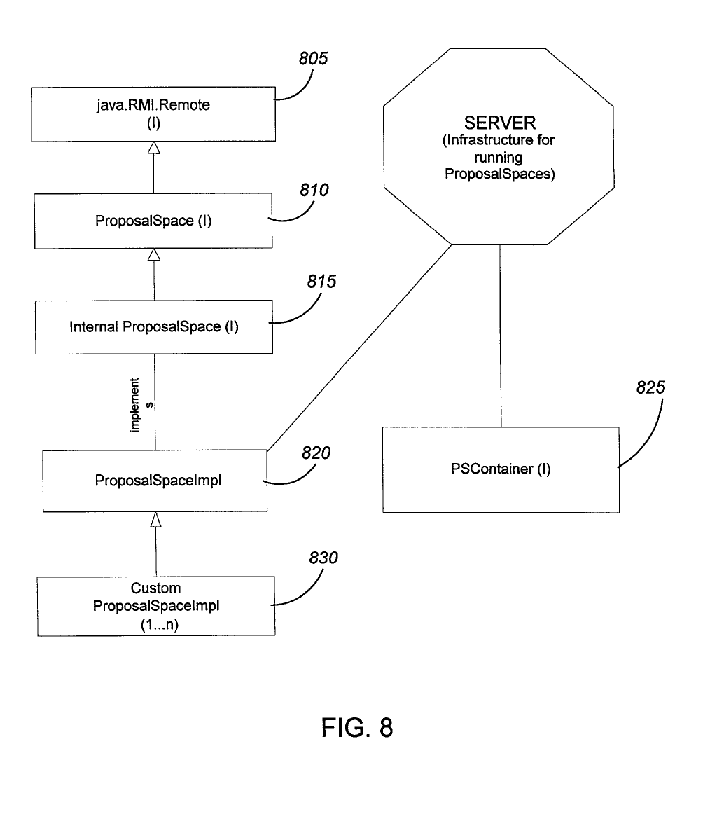

As described above, a ProposalServer provides the infrastructure for running ProposalSpaces. FIG. 8 shows the internal class structure of one ProposalServer implementation. The java.RMI.Remote interface (805) designates that this architecture's ProposalSpace is visible as a Java distributed cross-process object. The ProposalSpace interface (810), which inherits from the java.RMI.Remote interface, describes the ProposalSpace's contract with its application clients. The java.RMI.Remote interface contains the published ProposalSpace API. The methods of this interface are presented in Table 3 below. The arguments in Table 3 are listed and explained separately in Table 6.

TABLE 3
Methods used in the ProposalSpace interface

| Method | Arguments | Description |
|---|---|---|
| checkPrivilege | context | Checks a privilege for a |
| | checkContext | given user. |
| | privilege | |
| cloneObject | context | Returns a copy of an object |
| | objectId | with a specified objectId. |
| | | The cloned object is not |
| | | known to a given |
| | | ProposalSpace until the |
| | | client code explicitly |
| | | saves it. |
| cloneObjectReadOnly | context | Clones an object in a |
| | objectId | ProposalSpace and returns |
| | | a version to client that |
| | | cannot be saved back into |
| | | the ProposalSpace. No |
| | | record of the read only |
| | | clone is kept in the |
| | | ProposalSpace. |
| copyObject | context | Creates a copy of an object |
| | objectId | in a ProposalSpace and |
| | targetSpaceName | attempts to move that copy |
| | | into the ProposalSpace. |
| | | The space of origin |
| | | will not keep a record of |
| | | the copied Proposal. |
| createObject | context | Creates a new object for |
| | objectType | use by the client. This |
| | | object is assigned a unique |
| | | ID but is not recognized by |
| | | the space as a member until |
| | | it is saved for the first time |
| deleteObject | context | Deletes a specified |
| | objectId | object from a given |
| | | ProposalSpace. An object |
| | | cannot be deleted if it is |
| | | locked. |
| exists | context | Finds out if an object exists |
| | objectId | |
| executeScript | ScriptName | Executes the script |
| | contextList | associated with this event. |
| | args | |
| | context | |
| getChildrenSpaceNames | context | Returns the fully qualified |
| | | names of all the direct |
| | | children spaces of a |
| | | ProposalSpace. All names |
| | | will be returned regardless |
| | | of whether the |
| | | ProposalSpaces are up and |
| | | running or not. |
| getObject | context | Returns an object from a |
| | objectId | ProposalSpace to the |
| | | calling client. The object |
| | | is scoped to the calling |
| | | client and has a pointer |
| | | back to the ProposalSpace. |
| | | For certain types of objects |
| | | a lock can be set to dis- |
| | | allow other clients access |
| | | to the object. |
| getObjectProperties | context | Returns properties about |
| | objectId | an object in the |
| | | ProposalSpace. The |
| | | properties can include |
| | | metadata about the object |
| | | or instance data about the |
| | | object. The object's type |
| | | and the object's ID will |
| | | always be included. |
| getObjectProperties | context | Same as |
| | objectIds | getObjectProperties above, |
| | | but returns several |
| | | properties for objects in a |
| | | ProposalSpace and |
| | | therefore makes it possible |
| | | to avoid multiple calls |
| | | through an RMI layer. |
| getObjectProperty | context | Returns a property about an |
| | objectId | object in a ProposalSpace. |
| | propertyName | |
| getParentSpaceName | context | Returns the fully qualified |
| | | name of the parent |
| | | ProposalSpace. |
| getProperties | context | Returns the properties of |
| | | this ProposalSpace. |
| | | Properties can provide |
| | | configuration information |
| | | to objects in the space. |
| | | Properties are inherited |
| | | from ancestor spaces. |
| getProperty | context | Same as getProperties |
| | propertyName | above, but returns a single |
| | | property of this |
| | | ProposalSpace. |
| getSiteId | context | Returns the site ID for the |
| | | site in which a |
| | | ProposalSpace lives. |
| getSpaceId | context | Returns the unqualified |
| | | space ID for a |
| | | ProposalSpace. |
| getSpaceName | context | Returns the fully qualified |
| | | name (combination of site |
| | | ID and space ID) of a |
| | | ProposalSpace |
| getUserMgmtAttribute | context | Returns an object that is |
| | securityContext | correlated with the user |
| | attributeName | identity as specified by the |
| | | securityContext parameter. |
| getUserMgmtGroups | context | Returns an array of group |
| | securityContext | names. Group membership |
| | | for a given user is typically |
| | | a way for access control |
| | | mechanisms to differentiate |
| | | users. |
| getUserMgmtProperties | context | Returns properties about a |
| | securityContext | given user. Properties are |
| | | typically things like the |
| | | user first and last names. |
| moveObject | context | Moves an object from one |
| | objectId | ProposalSpace to another |
| | targetSpaceName | ProposalSpace. The object |
| | | being moved is deleted. If |
| | | move is not supported for a |
| | | particular type of object |
| | | this method does nothing. |
| objectExists | context | Tests for the existence |
| | objectId | of an object in a |
| | | ProposalSpace. |
| objectLocked | context | Tests for the lock state |
| | objectId | of an object in a |
| | | ProposalSpace. |
| objectLockedBy | context | Returns the toString |
| | objectId | identifier of the security |
| | | context that has this |
| | | object locked. |
| releaseObject | context | Releases an object that is |
| | objectId | in a locked state. Does |
| | | nothing if the object is not |
| | | locked or locking is not |
| | | supported for the object |
| | | type |
| saveObject | context | Saves an object |
| | object | |
| saveObjects | context | Saves several objects |
| | objects | |
| searchObjects | context | Searches across all objects |
| | searchDef | in a ProposalSpace. Returns |
| | | the objectIds for all objects |
| | | that have met the search |
| | | criteria |
| sendEvent | context | Sends an event |
| | event | |

The internal ProposalSpace interface (815), which inherits from the ProposalSpace interface, describes the ProposalSpace's contract with other pieces of the architecture. It represents how ProposalSpaces are addressed by other ProposalSpaces and by the ProposalSpace's own first-class objects. Because its clients are architectural peers, it provides more capability than the public ProposalSpace interface.

Methods placed in the internal ProposalSpace interface are not to be called by end clients. Table 4 below contains the different methods used in the internal ProposalSpace API.

TABLE 4
Methods used in the internal ProposalSpace interface

| Method | Arguments | Description |
|---|---|---|
| getProperties | | Returns properties defined for this |
| | | ProposalSpace. ProposalSpace objects |
| | | can read these properties to configure |
| | | themselves. Properties on this |
| | | ProposalSpace can also be inherited for |
| | | ancestor ProposalSpaces. |
| getProperty | propertyName | Same as getProperties, but returns a |
| | | single property defined for this |
| | | ProposalSpace. |
| getSiteId | | Returns the ID of the site that a |
| | | ProposalSpace belongs to. |
| getSpaceId | | Returns the unqualified name of a |
| | | ProposalSpace. |
| getSpaceName | | Returns the fully qualified identifier |
| | | for a ProposalSpace, that is, |
| | | siteid:spaceid. |

The ProposalSpace container interface (825) describes the ProposalSpace contract with its servicing layer (which could be a server or a cluster of servers). An instance of this class is scoped to a logical ProposalSpace and is handed to a ProposalSpace upon construction. Multiple ProposalSpace instances can be run on a server representing the same logical ProposalSpace. Any state information that a ProposalSpace maintains is managed through the ProposalSpace container interface using get, set, and remove methods for various attributes. The different attributes are correlated with different objects and users active in this ProposalSpace. The ProposalSpace container interface manages the caching and clearing of these attributes based on the existence of their correlations. The methods used by the ProposalSpace container interface are listed in Table 5 below.

TABLE 5
Methods used in the ProposalSpace container interface

| Methods | Arguments | Description |
|---|---|---|
| cloneObject | context | Returns a copy of a |
| | objectId | ProposalSpace object in |
| | | a ProposalSpace. |
| cloneObjectReadOnly | context | Returns a clone of a |
| | objectId | specified object that |
| | | cannot be saved back |
| | | into this ProposalSpace |
| copyObject | context | Copies a ProposalSpace |
| | objectId | object in a ProposalSpace |
| | spaceName | and saves it to another |
| | | space. Does nothing if |
| | | the type of object is |
| | | not clone supported |
| createObject | context | Manufactures a new |
| | objectType | ProposalSpace object. |
| | | The object is assigned a |
| | | unique ID but is not |
| | | recognized by the |
| | | ProposalSpace as a |
| | | member until the first |
| | | time it is saved. |
| deleteObject | context | Deletes an object from a |
| | objectId | ProposalSpace. Does |
| | | nothing if delete is not |
| | | supported for that |
| | | particular type. |
| executeScript | scriptName | Executes the script |
| | contextList | associated with an event. |
| | args | |
| | context | |
| getAttribute | attributeName | Gets an attribute |
| | | associated with a |
| | | ProposalSpace. |
| getAttribute | objectId | Gets an attribute |
| | attributeName | associated with a |
| | | ProposalSpace. |
| getAttribute | securityContext | Gets an attribute |
| | attributeName | associated with a |
| | | particular client identity |
| | | and a ProposalSpace. |
| getAttribute | securityContext | Gets an attribute |
| | objectId | that is associated with a |
| | attributeName | particular client identity, |
| | | a ProposalSpace, and an |
| | | object in the |
| | | ProposalSpace. |
| GetChildrenNames | | Retrieves the fully |
| | | qualified space names of |
| | | all immediate children |
| | | ProposalSpaces (running |
| | | or not running) of a |
| | | ProposalSpace |
| getName | | Returns the fully |
| | | qualified ProposalSpace |
| | | name of a ProposalSpace |
| getObject | context | Returns an object stored |
| | objectId | in a ProposalSpace. The |
| | | object will be locked on |
| | | behalf of the calling |
| | | client if the type supports |
| | | locking. It returns null if |
| | | the object is already |
| | | locked by another client, |
| | | if object does not exist, |
| | | or if get is not supported |
| | | by the type. |
| getObjectProperties | context | Returns the properties of |
| | objectId | an object in the |
| | | ProposalSpace or null |
| | | if support for a particular |
| | | type or object does not |
| | | exist. Properties on the |
| | | object can include values |
| | | inherent in the object or |
| | | meta data describing the |
| | | objects type, state, or |
| | | structure. |
| getParentName | | Returns the fully |
| | | qualified name of a |
| | | ProposalSpace's parent |
| | | space (running or not). |
| | | Returns null if the |
| | | ProposalSpace has no |
| | | parent. |
| getProperties | | Returns properties that |
| | | have been specified in |
| | | the configuration of a |
| | | ProposalSpace and all its |
| | | ancestors. Properties |
| | | on the innermost |
| | | ProposalSpace take |
| | | precedence if there is |
| | | a name conflict. |
| getSiteId | | Returns the ID of the site |
| | | that this ProposalSpace |
| | | is registered with |
| getSpace | name | Returns a reference to a |
| | | running ProposalSpace of |
| | | the specified name or |
| | | null if the name is invalid |
| | | or the ProposalSpace is |
| | | not up and running. |
| getSpaceId | | Gets the unqualified |
| | | name of a |
| | | ProposalSpace. |
| getTimer | timerName | Returns a timer queue |
| | | associated and managed |
| | | by a ProposalSpace. |
| getUserManagementAdapter | | Returns the user |
| | | management adapter |
| | | configured for a |
| | | ProposalSpace. The user |
| | | management adapter can |
| | | be used to retrieve more |
| | | information about a |
| | | particular client. |
| moveObject | context | Moves a ProposalSpace |
| | spaceName | object from one |
| | | ProposalSpace to |
| | | a designated |
| | | ProposalSpace and does |
| | | nothing if move not |
| | | supported for objects |
| | | type. |
| objectExists | context | Checks to see if an object |
| | objectId | with the given ID exists |
| | | in this ProposalSpace. |
| receiveEvent | event | Receives an event. |
| releaseObject | context | Unlocks an object in a |
| | objectId | ProposalSpace. Does |
| | | nothing if the object type |
| | | does not support locking |
| | | or if object is not locked. |
| removeAttribute | attributeName | Removes an attribute |
| | | from the cache. The |
| | | attribute is correlated |
| | | with a ProposalSpace. |
| removeAttribute | objectId | Same as removeAttribute |
| | attributeName | above, but is correlated |
| | | with a ProposalSpace and |
| | | an object in the space. |
| removeAttribute | securityContext | Same as removeAttribute |
| | attributeName | above, but is correlated |
| | | with this ProposalSpace |
| | | and a client identity. |
| removeAttribute | securityContext | Same as removeAttribute |
| | objectId | above, but is correlated |
| | attributeName | with a ProposalSpace, a |
| | | client identity, and an |
| | | object in the |
| | | ProposalSpace. |
| removeTimer | timerName | Stops and removes a |
| | | timer queue form a |
| | | ProposalSpace. |
| saveObjects | context | Saves objects to a |
| | objects | ProposalSpace. Does |
| | | nothing with objects that |
| | | do not support saving. If |
| | | an object is previously |
| | | unknown to this |
| | | ProposalSpace it will be |
| | | added and locked if |
| | | object supports locking. |
| | | If an object is already |
| | | in the ProposalSpace |
| | | it will be updated. A |
| | | client cannot save an |
| | | object that it does |
| | | not have locked. |
| searchObjects | context | Searches for objects in |
| | searchDef | this ProposalSpace and |
| | | returns the logical |
| | | object IDs (LOID) for |
| | | the objects that match the |
| | | constraints included in |
| | | the properties object. |
| | | Properties that are sure |
| | | to be supported for any |
| | | type of object are |
| | | enumerated in the |
| | | PS_CONSTANTS |
| | | interface. |
| sendEvent | context | Sends an event. |
| | event | |
| setAttribute | attributeName | Sets a new attribute into |
| | attribute | cache. The attribute is |
| | | correlated with this |
| | | ProposalSpace. |
| setAttribute | objectId | Sets a new attribute into |
| | attributeName | cache. The attribute is |
| | attribute | correlated with this |
| | | ProposalSpace and an |
| | | object in the space. |
| setAttribute | securityContext | Sets a new attribute into |
| | attributeName | cache. The attribute is |
| | attribute | correlated with this |
| | | ProposalSpace and a |
| | | client identity. |
| setTimer | timerName | Sets a new timer queue |
| | timer | into the ProposalSpace. |

A summary of the arguments used in the above-described interfaces and a brief description of what they represent can be found in Table 6 below.

TABLE 6
Summary of arguments used in ProposalSpace interfaces

| Argument | Type | Description |
|---|---|---|
| args | Serializable | Arguments to a script |
| attributeName | String | Name of attribute |
| context | PSContext | Executing client |
| | | information |
| contextList | Labeled list | Values to be put into the |
| | | context of the script |
| event | PSEvent | Name of event |
| name | String | Fully qualified name of a |
| | | ProposalSpace |
| object | PSObject | Name of object |
| objectId | String | Unique ID of an object |
| objectIds | String | Unique IDs of objects |
| objects | PSobject [ ] | Name of objects |
| objectType | String | Type of object |
| propertyName | String | Name of property to |
| | | retrieve |
| scriptName | String | Name of script to execute |
| searchDef | PSSearchDef | Definition of what to search |
| | | for |
| securityContext | PSSecurityContext | User identity |
| spaceName | | Fully qualified |
| | | ProposalSpace identifier |
| targetSpaceName | String | Fully qualified name of |
| | | ProposalSpace to which an |
| | | object will be moved |
| timer | TimerQueue | The timer queue |
| timerName | String | Unique name of timer |
| | | queue |

The ProposalSpaceImpl block (820) in FIG. 8 is the implementation of ProposalSpaces that satisfied the “contracts” described in ProposalSpace interface and internal ProposalSpace interface.

The CustomProposalSpaceImpl (830) is any class that extends ProposalSpace functionality.

### THE DEVELOPEMENT ASPECT OF PROPOSALSPACES

This section describes ProposalSpaces from the point of view of a developer who needs to modify ProposalSpace behavior in an application or extend ProposalSpace behavior to create new types of ProposalSpaces.

Using the ProposalSpace application programming interface

This section describes how an application programmer can use the ProposalSpace application programming interface (API). First, it will be described how a user can gain access to a ProposalSpace, second it will be described how a user can obtain information about a ProposalSpace, third it will be described how a user can work with so called first class objects, and finally this section will describe how user information can be obtained.

Gaining access to a ProposalSpace

A user can gain access to a ProposalSpace object by retrieving the ProposalSpace using the ProposalSpaceAccessor method getProposalSpace. The ProposalSpace object communicates back to a ProposalSpace implementation running on a ProposalServer. The user does not have to know on which ProposalServer the ProposalSpace is being hosted, but only the name of a ProposalServer to which the client will be connected, the name of the ProposalSite, and the name of the ProposalSpace.

There are three steps involved in gaining access to a ProposalSpace: getting a ProposalSpaceAccessor, authenticating to the ProposalSpace environment, and getting the ProposalSpace.

The first step in gaining access to ProposalSpaces is to connect to a ProposalServer and get a ProposalSpaceAccessor, which is a special object used to gain access to ProposalSpaces. There is a static (or class) method in the ProposalSpaceAccessor class for doing this: ProposalSpaceAccessor.GetFromProposalServer (<serverURL>) Calling this method gets a ProposalSpaceAccessor from a ProposalServer to which a user has access rights. The server location can be entered as a URL in the format:

//serverAddress:serverPort/ProposalServer

The second step in gaining access to ProposalSpaces is to authenticate to the Access Control framework. A successful authentication establishes a session and creates a UserSession object that allows secure access to the ProposalSpaces. The UserSession object is used by virtually all of the public ProposalSpace methods. The UserSession object includes a PSContext object, which a ProposalSpace can use to retrieve user management information, such as the user's group memberships. The PSContext object serves as a set of credentials or an ID card that identifies the user to the ProposalSpace and evaluates the access the user is permitted to. A UserSession object can be crated by sending the message authenticate(<username>, <password>) to the ProposalSpaceAccessor that was gotten above.

The third step in gaining access to ProposalSpaces is to get the ProposalSpace. The method getProposalSpace asks the ProposalSpaceAccessor for a ProposalSpace. Since the getProposalSpace( ) method returns a ProposalSpace, the method must be cast to any specific ProposalSpace subclasses, for example, an auction space. The method getSiteSpace(<arg>) may be more convenient, for it automatically gets the master ProposalSpace, called a SiteSpace, at any given site:

<arg>==“*” returns the current site's SiteSpace; and

<arg>==null returns the outermost (“master”) SiteSpace.

Getting information about a ProposalSpace

A ProposalSpace stores a significant amount of information about itself. The following methods, described in Table 3 above, can be used to obtain this information: getSpaceId, getSpaceName, getSiteld, getParentSpaceName, and getChildrenSpaceNames.

Once a user knows the name of a ProposalSpace's parent and/or child ProposalSpaces (if any), the user can get a reference to one of those ProposalSpaces by using the Accessor procedures that were used to get the original ProposalSpace.

An alternative way for a user to obtain information about a ProposalSpace is to use ProposalSpace properties. For example, domain URLs can be defined as properties. This allows Proposals or DomainObjects within one ProposalSpace to address different back-end resources from those addressed by the same kinds of objects in another ProposalSpace. For example, an Auction in ProposalSite X can point to an Oracle database located behind the X firewall while an Auction in ProposalSite Z, using the same kinds of Proposals, will point to an SOS data store located behind the Z firewall.

Properties of ProposalSpaces are maintained in the ProposalSite registry. Properties are inherited. If a ProposalSpace is asked to produce these properties, the ProposalSpace contributes its own properties and collaborates with its ancestors (that is, the ProposalSpaces inside which it is nested) to provide their properties as well. If a property name collision occurs, then the innermost property is used.

Properties can be obtained with the methods getProperty and getProperties that are described in Table 3 above.

Working with first-class objects

ProposalSpaces may contain many different kinds of objects. Any object that has been configured so that it can fully participate in the ProposalSpace object model is called a “first-class object” of the ProposalSpace. First-class objects are known by name by the ProposalSpace, they can be viewed in an application programming interface (API), they can be separately enumerated by the ProposalSpace, and they can move along with a ProposalSpace when the ProposalSpace is deployed onto another server. First-class objects are named in a way that supplies sufficient information to the ProposalSpace to allow the ProposalSpace to reconstitute these objects as needed. In one implementation, the first-class ProposalSpace objects include Proposals, PropSpecs, TypeSpecDictionaries, DomainObjects, Scripts, Role Definitions, XML documents and Text documents. All first-class objects can be addressed with twelve common methods that are all explained in further detail in Table 3 above. Not all of the methods are supported for all first-class objects. Table 7 below shows a summary of the twelve methods and summarizes functionality across object types:

TABLE 7
Functionality across object types

| | | | | | | | Other Objects |
|---|---|---|---|---|---|---|---|
| | | | | | | | Customized for |
| | | Prop | TypeSpec | Domain | | | ProposalSpace |
| | Proposal | Spec | Dictionary | Object | Role | Scripts | use |
| cloneObject | X | | | | | | |
| CloneObject | X | | | | | | |
| ReadOnly | | | | | | | |
| copyObject | X | | | | | | |
| create | X | X | X | X | | | |
| deleteObject | X | X | X | X | | | |
| exists | X | X | X | X | X | X | X |
| getObject | X | X | X | X | X | X | X |
| MoveObject | X | X | X | X | | | |
| getProperties | X | X | X | X | X | X | X |
| getProperty | | | | | | | |
| releaseObject | X | | | | | | |
| SaveObject | X | X | X | X | | | |
| searchObjects | X | X | X | X | X | X | X |

Every first-class object has a type and unique identifier. A ProposalSpace object has a reference back to its ProposalSpace of origin and knows the ID of the client who holds it at the moment.

Obtaining user information

ProposalSpaces generally have a connection to a user management system that holds information about users. A user can use public methods on a ProposalSpace to retrieve this information. The user needs a reference to a client identity about which the user wants information. Three such methods (see Table 3 above) exist for retrieving information: getUserMgmtProperties, getUserMgmtGroups and getUserMgmtAttribute.

Extending the Base Implementation

New types of ProposalSpaces are created by subclassing ProposalSpaceImpl and adding behavior, in the form of new methods. In the course of doing this, application developers may need to use the ProposalSpace's Access Control and caching mechanisms. How this is done will now be described.

The container cache

The container cache is a mechanism for storing ProposalSpace state information on a server. The state information takes the form of Java objects implementing the Serializable interface.

The container cache facility is available from within a ProposalSpace. In one implementation, subclassing a ProposalSpace gives the developer access to twelve methods: four Setters, four Getters, and four Removers. The multiple Setter, Getter and Remover methods can all associate with a ProposalSpace, associate with a first-class objects in the ProposalSpace, associate with a user, or associate with a user-on-object duo. A complete listing of all the individual setter, getter and remover methods can be found in Table 5 above.

Access Control on ProposalSpaces

If a developer decides to implement new methods on a ProposalSpace, he or she may want to protect them with Access Control. The developer can make use of existing Access Control mechanisms through getters on the base implementation.

Access Control has to deal with a potentially large and diverse group of users interacting with several application objects under dynamically changing circumstances. To handle this complexity, Access Control is a dynamic role-based system in which access privileges are assigned to roles. The roles are in turn assigned to users, either as individuals or as members of a group. In brief, Access Control works like this. A user attempts an interaction with a secured object, such as accessing a ProposalSpace or opening a Proposal. This activates one or more role rules. Role rules are Java-like expressions crafted by the developer to yield role assignments. Each role rule yields a result: either the role is awarded or denied to the user. If the role is awarded, the user is entitled to the access privileges that the role has been assigned. The privileges determine how the user can interact with that object. The role calculations can be cached so that if a user accesses the object again, the awarding or denial of privileges occurs rapidly.

Implementing Access Control

Access Control can be established for ProposalSpaces, Proposals, field groups, fields, and notes. Each of these objects has a defined set of access privileges, discussed in more detail below. By taking advantage of all of the levels of Access Control, a developer can design a finely grained and highly customized control system. The main steps in the design process are as follows: determine which business principles can be enforced through Access Control; determine what roles are appropriate for the application; determine the application context in which a role should be granted to a user; determine what privileges should be assigned to each role; specify the role-privilege associations for the securable objects; and write the role rules that yield the appropriate role assignments.

Roles are defined by the developer to reflect the categories of users who will be active in a ProposalSite. The name of each role should describe in a general way what the holder of that role is entitled to do, but the real substance of the role comes from the privileges that the developer associates with it. Roles names are typically simple name strings. A complete role definition includes of the role name, the ProposalSpace for which the role is defmed, and the ProposalSite that hosts the ProposalSpace. If a Proposal will be moving from one ProposalSpace to another, the roles associated with it must be defined for each ProposalSpace. Role definitions can be stored as first-class objects of a ProposalSpace.

Identifying the appropriate roles requires analyzing the application as a whole. The developer needs to be aware of all of the objects that users could potentially interact with. The developer will also need to think about roles and privileges together. In effect, a role can be thought of as the name that the developer gives to a set of privileges that has functional meaning in the context of the developer's application.

Once a role is defined, access privileges can be assigned to it. An access privilege is an entitlement to a particular mode of access to an object in an application. A role can be associated with either ProposalSpace access privileges or Proposal access privileges or with both. For ProposalSpace roles, role-privilege associations are made in the ProposalSite Registry. For Proposal roles, the developer makes role-privilege associations in the PropSpec.

Access Control at the ProposalSpace Level

The discussion will now continue with how to establish role-privilege associations at the ProposalSpace level in particular. Privileges that involve dealing with Proposals or other objects in their entirety, such as moving, deleting, or copying them, are handled at the ProposalSpace level, while privileges that involve dealing with the internals of Proposals or other objects, access to sub-Proposal elements such as field groups and fields, for example, are handled at the Proposal level.

In one implementation, there are eleven ProposalSpace access privileges. These eleven privileges are listed in Table 8 below. A developer can define roles that have all, none, or any sub-set of the ProposalSpace privileges.

TABLE 8
ProposalSpace privileges

| Privilege | Description |
|---|---|
| ACCESS | Allows the user to see a ProposalSpace. |
| ADD | Allows the user to add a Proposal to the ProposalSpace. |
| CLONE | Allows the user to create a copy of an existing Proposal. |
| DELETE | Allows the user to delete a Proposal from the |
| | ProposalSpace. |
| DO_ACCESS | Allows the user to access DomainObjects in the |
| | ProposalSpace. |
| DO_INFO | Allows a user to obtain information about the |
| | DomainObjects in the ProposalSpace. |
| GET | Allows the user to get a Proposal from the |
| | ProposalSpace. |
| INFO | Allows a user to obtain information about the Proposals |
| | in the ProposalSpace. |
| INVOKE | Allow the user to invoke an operation defined by the |
| | ProposalSpace. |
| MOVE | Allows the user to move a Proposal from one |
| | ProposalSpace to another. |
| NEW | Allows the user to create a new Proposal in the |
| | ProposalSpace. |

Role Rules and Proposal Spaces

Role rules are the fulcrum of the Access Control system. Role rules are expressions that are triggered when a user attempts to access an object. The role rules dynamically determine what role(s) a given user has, and consequently what access privileges he or she has for that object. A role can also have privileges associated with more than one object. In this case, role rules must be attached to each kind of object. The role rules can be the same or different for the different objects. For example, if a role is granted access privileges to both a ProposalSpace and a type of Proposal, the role rule must be associated with both the ProposalSpace and the PropSpec for the Proposal.

Role rules are a sub-category of a rule class. The rule class is loaded at run time to execute the role rules. The result of the executed rules is always one or more roles assigned to a securable object in the User Management API. Role rules are Java-like expressions. Most of the conventions for Java expressions are observed, such as the use of parentheses and operator precedence. However, the rule syntax for rules associated with ProposalSpaces differs from standard Java usage in the following ways:

An expression in a role rule must evaluate to a boolean primitive data type.

A rule can make static method calls that return boolean to any Java class.

A rule can contain only a single Java-like expression.

A special syntax is provided to allow access to the RuleUser object (role rules only). The syntax is the use of the keyword “user” in the rule.

A special syntax is provided to allow access to the PSContext object. The syntax is the use of the keyword “context” in the rule.

A special syntax is provided to allow access to the ProposalSpace object for role rules. The syntax is the use of the keyword “ProposalSpace” in the rule.

A special syntax is provided to allow Proposal role rules to reference Proposal properties and property sets, using the keyword “properties” in the rule.

To write role rules for ProposalSpace access, a developer may use any of the following types of information: the userid in the ProposalSite Registry, user groups defined in the ProposalSite Registry, ProposalSpace methods, ProposalSpace properties, system date and time, or any combination of the above. There are also methods for accessing application specific data, which will be described below. Role rules evaluate to a boolean primitive data type. If the value returned is true, the specified role or roles is/are assigned.

The developer can associate arbitrary application specific information with the ProposalSpace to be used in role rules. A convenient way to save this data is in the securityContextCache of the ProposalSpace.

The developer can access and set such information using the ProposalSpace methods

public Serializable getSecurityContextAttribute(PSContext context, PSSecurityContext securityContext, String attributeName) throws RemoteException; and

protected void putSecurityContextAttribute(PSSecurityContext securityContext, String attributeName, Serializable attribute) throws RemoteException;

The “put” method is typically used in a subclass of ProposalSpaceImpl to add data to the ProposalSpace. This data is then available to the role rule through the ProposalSpace object passed in to the rule.

A role rule for a ProposalSpace can contain references to properties of the ProposalSpace using the method ProposalSpace.getProperty.

Using a static method call in a role rule may allow less coding of specific values into rules. In this case, the static method can compare the properties against a table of values it obtains from another source.

With respect to role rules, nested ProposalSpaces embody a containment relationship, not a hierarchical relationship. Role rules for nested ProposalSpaces are not related to or dependent upon the containing ProposalSpace or the contained ProposalSpace. The same is true of role rules for Proposals contained within ProposalSpaces.

A user can enter a nested ProposalSpace directly without entering the parent ProposalSpace. In this case, role rules are calculated for the parent ProposalSpace (and all containing parent ProposalSpaces) at the time the user accesses the nested ProposalSpace. The user must have access privileges to the parent ProposalSpace before access privileges to the nested ProposalSpace are granted. Each parent and nested ProposalSpace's role rules are calculated independently from each other.

How Role Rules for Proposal Spaces are Triggered

When role rules are triggered, the ProposalServer executes the rule code the developer has written. For ProposalSpace rules, this occurs when a user first accesses a ProposalSpace method or when a user first accesses a nested ProposalSpace method (in this case, ProposalSpace role rules for enclosing ProposalSpaces are also triggered). When an access control ProposalSpace method is invoked, the method ProposalSpaceImpl.checkProposalSpaceAccess is also invoked.

This method finds the rule class for the ProposalSpace and fires all the role rule methods in the rule class. There is only one rule class associated with a given ProposalSpace. The following actions trigger Proposal role rules:

A user first enters a ProposalSpace and the ProposalSpace is searched for Proposals.

When a user first tries to open a Proposal.

When a user saves a Proposal, Proposal role rules are triggered to re-compute roles for the newly saved Proposal.

Whenever an unresolved Proposal is partially or completely resolved by adding a key value to the root field group, Proposal role rules are triggered to recomputed roles for the new Proposal ID.

Whenever a user invokes the ProposalSpace method “cleanup”, the next access to a relevant Proposal for that user has no roles, causing the role rules to be fired when the next event of those listed above occurs.

A method named “cleanup” is used by a user management plug-in to clean up when a user is logged out of an application. It cleans up all roles for a user for all Proposals, or for all users of a given Proposal.

The generic, abstract class that implements access control is an Access Manager class. The Access Manager class contains the subclasses ProposalAccessManager and ProposalSpaceManager. When one of the triggering events listed above occurs, the Access Manager checks to see if the user has been assigned any roles in relationship to the securable object. If the user has not been assigned any roles, the Access Manager invokes any role rules associated with the securable object the user is attempting to access and assigns the resulting roles to the user.

Role rules can include in their calculation any runtime data from the RuleUser object, the PSContext object, the ProposalSpace object, the securable object itself (properties only for Proposal role rules), or the environment by calling static methods. Because the triggering of the rule occurs after a user is assigned to the Proposal but before the user can insert new field references into a newly created Proposal, the fields referenced in the rule cannot be inserted at the time the rule is triggered. Access Control can prohibit insertion of new fields, depending on the user role.

In addition to role rules being triggered by the actions listed above, role rules are also fired for a Proposal when an application user searches a ProposalSpace for Proposal names or properties. The application user can initiate the search, using the following methods:

getProposalProperties (Properties properties, PSContext user)

getProposalNames (Properties properties, PSContext user)

getProposalSpaceObjectNames(Properties properties, PSContext user)

getProposalSpaceObjectProperties(String name, PSContext user)

These methods match a given list of properties to match against the properties for all Proposals in the ProposalSpace and return only the Proposal names or properties that match. One of these properties can be a set of roles to match against the calculated roles for the Proposal. The set of roles is passed in a comma-delimited string given as the argument to the input property _ROLE_.

If the generic forms of these methods, getProposalSpaceObjectNames and getProposalSpaceObjectProperties, are used to search for objects that are not Proposals, then the _ROLE_ property is not used.

The ProposalSpace finds the rule class for each Proposal and fires all the role rule methods in the class to add roles for the Proposal user. The calculated roles for the given user are then compared against the set of roles passed in to the method, so that roles are treated like properties to filter the Proposals in the ProposalSpace. Only Proposals with roles assigned to the user that are contained in the set of input roles are returned to the user.

The roles calculated for filtering by ProposalSpace methods are also used for access control within the Proposal. However, the privileges associated with the roles are not used as a filter. For example, whether or not the Proposal is accessible to the user does not help to determine whether the Proposal property or name is returned from these methods.

Alternative implementation of access control and roles

The main ideas of access control and a role-based system are the same in this alternative implementation as in the previously described implementation. However, due to the implementation differences, the access control system works slightly different, as will be seen below. In this alternative implementation, the access control system works as follows. When a user tries to interact with a controlled object in some way, such as searching a ProposalSpace, opening a Proposal, adding a field group, or changing the value of a field, a role-assignment script attached to that object is activated. The role-assignment script uses the identity of the user, the status of the object, and business principles that a developer has written into the script to determine what role(s) that user merits with regard to that object. Each role that is awarded to the user entitles the user to certain access privileges toward that object. If the attempted operation is among these privileges, the operation is permitted. The role calculations are cached so that if the same user accesses the object again, the awarding or denial of privileges occurs rapidly.

In this alternative implementation, a developer needs to take the following steps to set the access control system up. First, the developer does an access control analysis to determine which of the application's business principles can be enforced through access control. The developer then determines what categories of users will be using the application and enters a name for each user into an XML file that will be saved in the ProposalSpace to which access control will be applied, or that contains objects to which access control will be applied. The developer adds to this XML file a list of which (if any) of the pre-defined ProposalSpace-access privileges (listed in Table 8 above) that holders of that role will have.

At another level, the developer specifies the access that holders of each role will have with regard to Proposals and sub-proposal elements such as individual data fields. The developer then writes scripts that will activate when a user attempts to access a ProposalSpace and scripts that will activate when a user attempts to access a Proposal or a field group.

Each role corresponds to a category of users who will be active in a site. Roles are defined at the ProposalSpace level. Only roles that have been defined in the ProposalSpace can be assigned by role scripts. Role definitions are first-class ProposalSpace objects. The role definitions are stored in the ProposalSpace in XML format and can be saved and retrieved using the standard ProposalSpace methods, and they can be copied from one ProposalSpace to another. Associating ProposalSpace-level access privileges involves specifying in the XML file which privilege(s) should be allowed to the holder of a given role.

Role-assignment scripts can be attached to ProposalSpaces, Proposals and field groups. Executing a script always results in one or more roles being assigned. If the script assigns no roles, then the system will assign the role _DEFAULT_, which has no associated privileges. The _DEFAULT_ role exists to indicate that the role script for the object has in fact been activated. If the only role assigned for a user for a Proposal is _DEFAULT_, no access is allowed and the Proposal is not returned by ProposalSpace filtering methods such as getProposalNames.

Just like in the implementation described above, a user can be assigned multiple roles with regard to an application object. When this occurs, the user is granted the sum of all of the privileges associated with the assigned roles. If the role assignments yield conflicting sets of privileges, the most permissive of those privileges prevails.

In this alternative implementation, ProposalSpaces role-assignment scripts are stored as ScriptDef objects and are written in the Python scripting language. They are not compiled. A RuleUser object wraps convenience methods for script writers. Examples of such convenience methods are getAttribute, getProperty, getSiteld, getUserId, isUserInGroup. References to data in the RuleUser object follow the same format as those for a Proposal. Most of these convenience methods are defined in Table 4 and Table 5 above. The isUserInGroup method checks whether the user is a member of a specific group. Additional methods can be developed, for example, where several groups are checked.

Information that can be referenced in a ProposalSpace role-assignment script includes RuleUser objects, ProposalSpaces, ProposalSpace contexts (PSC), Script names and Roles. Roles is a special variable, an instance ofjava.util.Set. In order to assign a role to a user, the role name has to be added to the Roles variable, as in the following example:

roles.add(“bidder”)

After the script is executed, all roles from the Roles variable set are assigned to the user, so that roles not found in the ProposalSpace will be rejected. There are also methods for accessing application-specific data. Application-specific data can be associated with the ProposalSpace for use in role scripts. A convenient way to save this data is in the securityContextCache of the ProposalSpace. The application-specific information can be accessed and set using the following ProposalSpace methods:

public Serializable getSecurityContextAttribute (PSContext context, PSSecurityContext securityContext, String attributeName) throws RemoteException;

protected void putSecurityContextAttribute (PSSecurityContext securityContext, String attributeName, Serializable attribute) throws RemoteException;

The “put” method is typically used in a subclass of ProposalSpaceImpl to add data to the ProposalSpace. This data is then available to the script through the ProposalSpace object passed in to the script.

Role assignments are not inherited. Where role scripts are concerned, nested ProposalSpaces embody a containment relationship rather than a hierarchical relationship. The role scripts attached to containing and contained ProposalSpaces are executed independently from each other. A user can enter a nested ProposalSpace directly without entering the parent ProposalSpace. In this case, role scripts are executed for the parent ProposalSpace (and all containing parent ProposalSpaces) at the time the user enters the nested ProposalSpace. The user must have access privileges to the parent ProposalSpace before access privileges to the nested ProposalSpace are granted.

Role scripts on a Proposal are also fired when an application user searches a ProposalSpace for Proposal names or properties. The application initiates the search, using the method searchObjects(PSContext context, SearchDef searchDef ). SearchDef defines a set of constraints for matching a set of properties against the properties for all Proposals in the ProposalSpace. It returns only the Proposal names or properties that match. One of the constraints may be a set of roles to match against the calculated roles for the Proposal. The set of roles is passed in a comma-delimited string given as the argument to the input property _ROLE_. If the generic forms of the methods getProposalSpaceObjectNames and getObjectProperties are used to search for objects that are not Proposals, then the _ROLE_ property is not used. The ProposalSpace finds the role script in the properties store for each Proposal and fires the role script methods in the class to add roles for the Proposal user. The calculated roles for the user are then compared against the set of roles passed in to the method, so that roles are treated like properties to filter the Proposals in the ProposalSpace.

The only Proposals in the ProposalSpace that are returned to the user are those with roles assigned to the user that are contained in the set of input roles. The roles calculated for filtering by ProposalSpace methods are also used for access control within the Proposal. However, the privileges associated with the roles are not used as a filter. For example, whether or not the Proposal is accessible to the user does not help to determine whether the Proposal property or name is returned from these methods.

Alternative implementation of proposal container in an EJB environment

An implementation of ProposalSpaces has been described in which they are implemented in a self-contained, stand-alone environment whose components are directly addressed by client processes. Alternatively, proposal containers can be implemented in the context of a larger environment, as will now be described. This permits some of the components and services of the proposal container to be replaced by generic components and services provided by the environment, and proposal containers implemented in this way can more easily interact with external, non-proposal-based components.

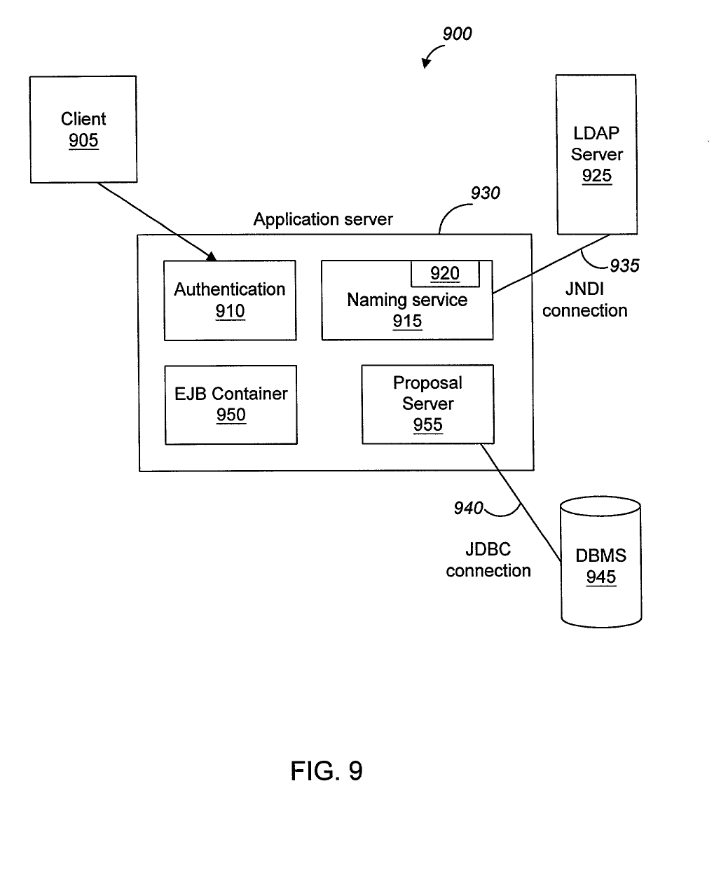

In one alternative implementation, proposal containers are placed within an EJB (Enterprise Java Beans) environment. This involves several modifications to the previously described implementation, which will now be described with reference to FIG. 9.

A proposal server process is embedded as a module (955) in a J2EE™ (Java™ 2 Platform Enterprise Edition) application server (930). The RMI (Remote Method Invocation) function of the ProposalServer is not provided, and the communication service in the application server (930) used instead. The authentication function of the ProposalServer is not provided, and the authentication service (910) of the application server (930) is used instead.

The monolithic ProposalServer is broken into multiple discrete services. This makes the implementation more modular, so that new capabilities can be added easily. In addition, it can be independently managed by the management protocols of the JMX (Java™ Management Extensions) environment.

The proposal server process (955) includes a bootstrap loader plus a set of services. The bootstrap loader is generally different for each deployment. The bootstrap loader is responsible for starting all proposal and proposal container components and connecting the proposal module into the server framework in which it is running. The bootstrap loader starts up the proposals and proposal container components and makes a service provider interface (SPI) available to the application server (930).

The existence of the SPI is another difference compared to the previously-described implementation. What was in the application programming interface of the ProposalServer is in two interfaces (SPI and API) of the proposal server process (955). In this implementation, the API is exposed to application developers and applications, while the SPI provides the lower-level services that support the API. The API is designed to be convenient to use and easy to understand and to shield developers from the details of the architecture's internals. This split promotes additional modularity, since the API can change to respond to the needs of application developers while the SPI remains stable, and vice versa.

The set of services, represented as modules, include:

Locking service—places locks on first-class objects, as a way to ensure that no more than one client holds any object at one time;

Domain service—permits connections to persistent storage, such as database and file system;

Directory service—provides configuration information to installation;

Message service—allows the sending and receiving of messages through JMS (Java Message Service);

Cache service—implements persistent caching mechanism, a run-time cache that other services can use to store state;

Log service—writes out a log that can be used for debugging, diagnosing exceptions, and so on;

Queue service—allows an application to call methods (with arguments) contingent upon something else having happened;

Extension service—permits customizing functionality by invoking either a Java extension or a Python script and latching this customized code onto various events;

Container service—implements the SPI and presents it to the outside world;

Sequence service—generates series of sequential numbers to provide unique key values to applications;

Search service—allows searching the profiles of various first-class objects in a proposal container;

User service—allows connection to a user management system to get data about various users; it is configured to start up an adapter that can talk to a third-party user management system;

Timer service—provides other services with “pings” at scheduled intervals, so that those other services can run scheduled tasks; and

Remote service—allows connecting to and communicating with proposal containers located remotely as if they were local.

In the present implementation, the kinds of information that were stored in the ProposalRegistry are stored in a JNDI (Java Naming and Directory Interface) compatible directory service such as LDAP (Lightweight Directory Access Protocol). The proposal server process (955) obtains the information it needs through a JNDI interface (935). An LDAP (or other) server (925) performs as the registry database server.

The procedure for getting a proposal container also differs in the EJB implementation. In the ProposalSpace implementation, the client process gets a ProposalSpaceAccessor from the ProposalServer. In the present implementation, the proposal server process (955) puts the ProposalSpaceAccessor (930) into the application server's naming service (915), and the client (905) gets it from there.

The static method for getting a proposal container gets a reference to a JNDI compatible naming service as follows: ProposalSpaceAccessor psa=naming.lookup (“ProposalSpaceAccessor”). The client connects and authenticates to the application server instead of the ProposalServer.

A number of implementations of the invention have been described. Nevertheless, it will be understood that various modifications can be made without departing from the spirit and scope of the invention. For example, new first-class objects can be added; additional life-cycle events upon which proposal containers can hang behavior can be added; proposal containers can be distributed across multiple servers for fail-over purposes; the forms in which behavior can be hooked on to life-cycle events can change (Java rules, Python scripting, and so on); and proposal containers can be implemented as collections of peer nodes.

What is claimed is

1. A system for organizing information, comprising:
a computer program subsystem comprising instructions operable to cause the system to maintain a first digital container object for containing proposal objects and to perform actions on the proposal objects, the instructions comprising instructions to:
receive a first proposal object, the first proposal object holding data that represents a proposed transaction in an uncommitted state, and add the received first proposal object to the first digital container object;
release and remove the first proposal object from the first digital container object;
store in a non-volatile memory a then-current state of all proposal objects in the first digital container object and of the first digital container object itself;
control access by a user to the first digital container object and to proposal objects in the first digital container object; and
perform one or more actions on the first proposal object in response to an event related to the first proposal object or an event related to the first digital container object, including instructions to complete any data processing associated with the first proposal object, to submit the first proposal object for further processing to a second computer program subsystem maintaining a second digital container object for containing proposal objects, and to perform one or more actions on the first proposal object when it is received to be added to the first digital container object.

2. The system of claim 1, wherein the event is triggered by the first proposal object.

3. The system of claim 1, wherein the event is triggered by a second proposal object in the first digital container object.

4. The system of claim 1, wherein the event is a time-related event.

5. The system of claim 1, wherein the event is a proposal life-cycle event.

6. The system of claim 1, wherein the actions in response to the instructions to complete any data processing associated with the proposal object comprise:
moving data contained in the proposal object to a permanent asset store; and
archiving the proposal object in a permanent asset store or deleting the proposal object from the system.

7. The system of claim 1 wherein the subsystem is distributed for execution by two or more independently operating computers.

8. The system of claim 1, wherein the subsystem further comprises instructions to:
perform an action on the first proposal object in the first digital container object based on information related to a second proposal object in the first digital container object and to a state of the subsystem.

9. The system of claim 8, wherein the subsystem further comprises instructions to:
obtain data from the first proposal object in the first digital container object and supply the data to the second proposal object in the first digital container object.

10. The system of claim 1, wherein the subsystem further comprises instructions to:
obtain data from the first proposal object in the first digital container object and supply the data to a data document.

11. The system of claim 1, wherein the data document is an XML document.

12. The system of claim 1, wherein the subsystem further comprises instructions to:
obtain data from a data document and supply the data to the first proposal object in the first digital container object.

13. The system of claim 1, wherein the data document is an XML document.

14. The system of claim 1, wherein the instructions to control access by a user to the first digital container object and to proposal objects in the first digital container object comprises instructions to:
associate the user with a role; and
associate the role with specific access rights.

15. The system of claim 1, wherein the actions are context dependent actions.

16. The system of claim 1, wherein the actions are customizable by a user.

17. The system of claim 1, wherein the first digital container object is contained in a nested structure of digital container objects.

18. The system of claim 17, wherein the first digital container object is in a second digital container object in the nested structure and the first digital container object inherits one or more properties of the second digital container object.

19. The system of claim 17, wherein the nested structure of digital container objects is independent of the physical structure of the platforms hosting the digital container objects

20. A system for administering a collection of digital container objects, the system comprising a registry server and a registry database, each digital container object being defined by computer program instructions and data configured to be loaded onto and executed by a computer process, the registry server comprising a computer process operating in communication with the registry database, the system further comprising:
container-configuration data for multiple digital container objects, the container-configuration data for each digital container object comprising a specification defining the digital container object;
instructions executable by the registry server to use the container-configuration data for any of the multiple digital container objects in creating a digital container object satisfying the corresponding specification on a particular computer;
container-location data specifying a computer location for each digital container object created in conjunction with the registry server, whereby any such digital container object can locate any other such digital container object; and
container-store data for each digital container object specifying a persistent store for the corresponding digital container object, whereby any such digital container object can be saved and retrieved by the system;
wherein the digital container objects collectively operate to create, contain, transfer, operate on, and terminate digital proposal objects, the proposal objects each representing a proposed transaction in an uncommitted state; and
wherein the digital container objects comprise a first digital container object that interacts with a user and performs a specialized activity on proposal objects contained in the first digital container object.

21. The system of claim 20, wherein the registry server and database further comprise:
instructions executable by the registry server to use registry database data to configure a computer process as a digital container object server, a digital container object server being a computer process registered with the registry server and configured to host one or more digital container objects.

22. The system of claim 20, wherein:
container-configuration data for a digital container object comprises data specifying access control parameters for the digital container object;
the specialized activity comprises an action performed when a proposal object enters the first digital container object and an action performed when a proposal object leaves the first digital container object; and
the system further comprises instructions executable to migrate a proposal object from one digital container object to another digital container object.

23. The system of claim 20, wherein the digital container objects in the collection perform a particular kind of activity, such as matching buyers and sellers, enabling collaboration on a product design, assembling group orders or bids, aggregating forecasts or projections composed of input from multiple sources, prioritizing or ranking multiple offers or entries.

24. A digital container object for maintaining proposal objects, each proposal object holding data representing a proposed transaction in an uncommitted state, the digital container object comprising computer program instructions embodied in a tangible medium implementing methods operable to:
detect an introduction of a first proposal object into the digital container object;
detect a removal of the first proposal object from the digital container object;
perform one or more actions on the first proposal object in the digital container object in response to the detected introduction or removal of the first proposal object; and
apply access control conditions to limit the actions that can be performed by a user on the proposal objects in the digital container object.

25. The digital container object of claim 24, further comprising instructions implementing methods operable to:
perform one or more actions on a second, different proposal object in the digital container object in response to the detected introduction or removal of the first proposal object.

26. The digital container object of claim 24, wherein the methods operable to detect an introduction of the first proposal object comprise methods operable to:
detect a creation of the first proposal object in the digital container object.

27. The digital container object of claim 24, wherein the methods operable to detect an introduction of the first proposal object comprise methods operable to:
detect an immigration of the first proposal object into the digital container object from another digital container object.

28. The digital container object of claim 24, wherein the methods operable to detect a removal of the first proposal object comprise methods operable to: detect a deletion of the first proposal object from the digital container object.

29. The digital container object of claim 24, wherein the methods operable to detect a removal of the first proposal object comprise methods operable to:
detect an emigration of the first proposal object from the digital container object to another digital container object.

30. The digital container object of claim 24, further comprising methods operable to perform one or more actions on one or more proposal objects in the digital container object in response to an instruction generated by a proposal object in the digital container object.

31. The digital container object of claim 24, further comprising methods operable to:
perform one or more actions on one or more proposal objects in the digital container object in response to a time-related event.

32. The digital container object of claim 24, further comprising methods operable to:
perform one or more actions on one or more proposal objects in the digital container object in response to a life-cycle event for a proposal object.

33. The digital container object of claim 24, further comprising methods operable to:
store in a non-volatile memory a then-current state of the digital container object and to cause the proposal objects contained in the digital container object to store their own then-current states in a non-volatile memory so as to create a persistent digital container object wi th a persistent state including contained proposal objects.

34. The digital container object of claim 24, further comprising methods operable to:
detect a complete event for a proposal object, the proposal object holding data representing a proposed transaction;
move the data contained in the proposal object to a permanent asset store; and store the proposal object in a permanent asset store or delete the proposal object.

35. The digital container object of claim 24, further comprising methods operable to:
obtain data from a data document and supply the data to the first proposal object in the digital container object.

36. The digital container object of claim 24, wherein the data document is an XML document.

37. The digital container object of claim 24, further comprising methods operable to:
obtain data from the first proposal object in the first digital container object and supply the data to a data document.

38. The digital container object of claim 24, wherein the data document is an XML document.

39. The digital container object of claim 24, wherein the action is a context-dependent action.

40. The digital container object of claim 24, wherein the actions are customizable by a user.

41. The digital container object of claim 24, wherein the methods operable to apply access control conditions comprise methods operable to:
associate a user with a role; and
associate the role with specific rights to access all the proposal objects in the digital container object.

42. The digital container object of claim 41, wherein the methods operable to apply access control conditions further comprise methods operable to:
associate the role with specific rights to introduce or remove proposal objects from the digital container object.

43. The digital container object of claim 24, wherein the digital container object is distributed on two or more servers in communication over a network.

44. The digital container object of claim 24, wherein:
the proposal object is a middle-tier object that is independent of both any front-end and any back-end.
